(19) United States
(12) Patent Application Publication
(10) Pub. No.: US 2012/0038520 A1
(43) Pub. Date: Feb. 16, 2012

(54) OMNI-DIRECTIONAL ANTENNA SYSTEM FOR WIRELESS COMMUNICATION

(75) Inventor: James CORNWELL, Inyokern, CA (US)

(73) Assignee: KAONETICS TECHNOLOGIES, INC., Inyokern, CA (US)

(21) Appl. No.: 13/208,265

(22) Filed: Aug. 11, 2011

Related U.S. Application Data
(60) Provisional application No. 61/372,842, filed on Aug. 11, 2010.
(60) Provisional application No. 61/381,611, filed on Sep. 10, 2010.

(51) Int. Cl. H01Q 1/48; H01Q 9/04; H01Q 1/24

(52) U.S. Cl. 343/702; 343/848; 343/700 MS

(57) ABSTRACT

A wireless device having an improved antenna system is disclosed comprising one or more antenna, preferably circularly polarized antenna, for transmitting or receiving a signal, and one or more floating ground planes, wherein the floating ground plane preferably is electrically isolated from and in sufficient proximity to the antenna so that it is inductively coupled to the antenna. The floating ground plane may comprise one or more of a strip, band, foil, plate, block, wire mesh, sheet or coating of conductive material and, for example, may be a relatively thin copper strip, band, foil or coating. The circularly polarized antenna, preferably comprises a flat planar shaped radiating element sized and configured to resonate at a predetermined, desired frequency, frequencies or band of frequencies, and a flat planar shaped antenna ground, both radiating element and antenna ground formed on the same printed circuit board. The radiating element is electrically isolated from the antenna ground but sufficiently close to resonate at the desired frequencies. Preferably the floating ground plane is larger than or more massive than the antenna ground, and preferably larger than or more massive than the radiating element. In a further embodiment the wireless device comprises a housing for interfacing with a user, the housing comprising a conductive contact exposed to the exterior of the housing and configured to be contacted by a user, wherein the conductive contact is electrically connected to the floating ground plane, preferably so that the user is coupled to the antenna and becomes part of the antenna system. The floating ground plane may also preferably be configured to substantially cover or overlap the antenna, and may also be configured to distribute and propagate the electromagnetic signals away from the head of the user.

### CROSS REFERENCE TO RELATED APPLICATIONS

This application claims the benefit of U.S. Provisional Application No. 61/372,842 filed Aug. 11, 2010 and U.S. Provisional Application No. 61/381,611 filed Sep. 10, 2010, the entire contents of both of which are incorporated by reference herein.

### FIELD OF THE INVENTION

The present invention relates to antennas that transmit and/or receive radio frequency (RF) signals and other electromagnetic signals including antennas for use in mobile, cellular or other wireless phones, desktop computers, notebook computers, laptop computers, tablets, servers, televisions, radios, Very High Frequency (VHF) radios, satellites, Ground Position Satellite (GPS) units, WiFi units, wireless routers, radio frequency controllers, robot devices, Bluetooth enabled devices, or other devices that communicate wirelessly.

### BACKGROUND OF THE PRESENT INVENTION

Conventional antennas inclusive of television, radio, GPS, wireless routers, WiFi, wireless and cellular phones, typically experience signal loss due to attenuation. This occurs when the path of the propagating electromagnetic wave is obstructed or partially obstructed. Depending on the structure and density of the materials, the attenuation loss and signal interruption can be greater through certain materials than others. Conventional wireless devices typically use linearly polarized antennas (horizontally or vertically polarized antennas), whereby the high frequency signals, such as for example, radio frequency and microwave transmissions, work and transmit by line of sight. In such situations the signal can be interrupted by material obstructions, such as, for example, buildings, mountains and other obstructions, that interfere with the straight line of sight communication of the wireless devices.

For a mobile, cellular or wireless phone, signal loss also typically occurs when your hand or other body parts attenuate on sensitive parts of the mobile phone's antenna. As a result of the mass and density of the human body, a coupling effect occurs which may detune the antenna, and/or grounds out (shorts out) the antenna, and signal transmission is reduced in the case of a detuned antenna, or transmission may be terminated if the antenna grounds out. For example, on the Apple iPhone 4 there are multiple linearly polarized antennas. A particularly sensitive area on the original Apple iPhone 4 is the black strip on the lower left corner which surrounds the entire circumference of the mobile phone. There appears to be a linearly polarized WiFi data antenna in the lower left hand corner of the iPhone 4 which may become detuned when a user places a body part such as their finger, thumb or ear in the lower left hand corner of the phone, particularly when the body part contacts the black strip in the lower left corner of the phone housing. This may cause the antenna in the lower left corner of the phone housing to become detuned which reduces the data transfer rate.

Other problems with conventional antennas and the transmission and reception of radio frequencies, including microwave frequencies, is that interference between propagating signal waves can cause wave cancellation and can result in loss of signal strength. This wave cancellation and loss of signal strength can result from a signal wave interfering with itself as a result of reflecting off of surfaces and self-cancelling, or may result from a separate signal source. Because of this wave cancellation problem, cell phone towers, WiFi spots, radio and television broadcasts, jammers, and other communication devices are subject to signal loss and avoid overlapping coverage areas. To avoid overlapping coverage issues, technologies have been developed, for example, to hand off mobile phone signals from tower to tower to avoid overlapping coverage areas and the loss of signal strength and dropped calls.

Further problems in connection with mobile phones and other wireless technology include the radiation and health effects of being exposed to electromagnetic radiation, and in particular high frequency radio and microwaves associated with mobile phones, especially when these devices are used so close to the human body, and in particular the head of the human body.

### SUMMARY OF THE INVENTION

By installing a circularly polarized (CP) antenna configuration into a wireless transmitting and/or receiving device, such as, for example, radio frequency controllers, wireless routers, Bluetooth enabled devices, WiFi devices, robot devices, cellular or wireless phones, global positioning satellite (GPS) devices, radios, televisions, computers, tablets, notebook and laptop computers, etc., the problem of attenuation loss due to obstructions and interference materials such as buildings, mountains, etc., which interfere with and obstruct the wireless signal may be reduced and/or eliminated. By utilizing the circularly polarized antenna and system as described herein, high frequency transmitter and receiver devices become substantially omni-directional receivers and/or transmitters. That is, by utilizing one or more circularly polarized antennas configured as provided herein, high frequency and microwave wireless systems, for example 1.2 GHz and 5.8 GHz systems, become substantially omni-directional antennas as opposed to line of sight antenna systems that are subject to environmental and other obstructions that interfere with the transmission and reception of the signals by the antenna.

The antenna may be configured as described and shown in U.S. Pat. No. 7,733,280. In one embodiment the circularly polarized antenna may be configured as shown in FIG. 4 of U.S. Pat. No. 7,733,280 where the antenna has a ground and a radiating element. Preferably the circularly polarized antenna has a substantially flat, planar, conductive radiating element and the signal transmits or is received from the edges of the radiating element. In a preferred embodiment the antenna ground may be a substantially flat, planar, conductive material that preferably is larger than the radiating element, and preferably at least one dimension of the antenna ground is about three to about four (about 3-4) times larger than the respective dimension of the radiating element. Other circularly polarized (CP) antenna are also contemplated.

By placing one or more dedicated or floating grounding plane(s), such as, for example, a strip, band, plate, block, sheet, wire mesh, foil, or coating of conductive material, for example, metal, in the device and inductively coupling the floating grounding plane (e.g., metal strip) to the antenna, preferably a CP antenna, by electrically isolating it from and placing it in proximity to the antenna, it is believed that the floating grounding plane (e.g., metal strip) couples the wireless device to the antenna and the wireless device becomes part of the overall antenna radiating system. The results have been experimentally proven with very positive results. The transmission has a much higher equivalent isotropically radiated power (EIRP), sometimes referred to as gain, with increases from 33% of power transmitted to >95% of transmitted power radiated.

In one embodiment, an antenna system for a wireless device having a housing is provided that comprises one or more circularly polarized antenna for transmitting or receiving a signal, and one or more floating ground planes, wherein the floating ground plane is electrically isolated from yet in proximity to the antenna so that it is inductively coupled to the CP antenna. The floating ground plane may comprise one or more of a strip, band, foil, plate, block, wire mesh, sheet or coating of conductive metal and, for example, may be a relatively thin copper strip, foil or sheet. Preferably the floating ground plane is larger than or more massive than the antenna ground, and preferably larger than and more massive than the radiating element. Generally, the larger the size and mass of the floating ground plane, the better the performance of the antenna system. In some applications the floating ground plane may comprise copper or aluminum mesh or foil wrapped partially or completely about or around the interior or exterior of the wireless device, and may form the housing of the wireless devices, or parts or pieces of the housing.

The floating ground plane may be located a distance of about 1 mm or less from the CP antenna, to several centimeters from the CP antenna, to several inches from the CP antenna depending upon the operating power of the wireless device and operating frequency of the antenna, among other factors. In one embodiment of a lower power device (about 0.6 watts), the floating ground plane is located a distance of about 2 millimeters from the antenna, and in another embodiment of slightly higher power (about two to four watts) the floating plane is about 25 mm to about 30 mm from the antenna, and in yet other embodiments of higher power (about 150 watts), the floating ground plane may be as far away as about six (6) inches to about eight (8) inches from the antenna, depending upon a number of factors, including the operating frequency of the antenna and the operating power. Generally, the closer the floating ground plane can be located to the antenna without arcing or shorting, the better the performance of the antenna. The floating ground plane in one embodiment is connected to the ground of the wireless device. In yet another embodiment the floating ground plane is connected to metallic elements on the exterior of the device housing, and may be connected to the exterior of the device housing. The floating ground plane may be connected to both the ground of the wireless device and connected to the exterior of the device housing or metallic elements on the exterior of the device housing.

In one embodiment, an antenna system for a wireless device is provided comprising an antenna, preferably a circularly polarized antenna, for transmitting or receiving a signal, and a floating ground plane, wherein the floating ground plane is in proximity to the antenna so that floating ground plane is inductively coupled to the antenna. The floating ground plane preferably is electrically isolated from and in close proximity to the ground of the antenna. The closer the floating ground plane is to the antenna without arcing or shorting, generally the better the performance of the antenna and the better the Voltage Standing Wave Ratio (VSWR). The floating grounding plane may comprise one of the group of a strip, band, foil, coating, mesh, sheet, block and plate of conductive metal, such as, for example, relatively thin copper or aluminum foil. The antenna system and/or wireless device may further comprise a housing.

The circularly polarized antenna preferably has a radiating element and an antenna ground and the radiating element preferably is electrically isolated from and located about one (1) mm to about ten (10) mm from the ground of the antenna. The radiating element may be a relatively thin conductive sheet, strip, band, foil, mesh or coating having a length and height and may be formed on a printed circuit board. The relatively thin conductive radiating element may be substantially flat and planar-shaped or may take the form of shapes and have curves. The circularly polarized antenna may further include a conductive antenna ground formed as a relatively thin sheet, strip, band, mesh, foil or coating and may be formed on a printed circuit board. The relatively thin conductive antenna ground may be substantially flat and planar-shaped or may take the form of shapes and have curves. The radiating element and the antenna ground may both be formed on a printed circuit board and oriented in the same plane. Alternatively, the radiating element and the antenna ground may be oriented in different planes. The antenna system may comprise a plurality of antennas including one or more radiating elements and/or one or more antenna grounds, and the various radiating elements and antenna grounds may be oriented in the same or different planes.

In an embodiment, the circularly polarized antenna has a planar shaped, conductive antenna ground formed as a relatively thin sheet, foil or coating. The antenna ground preferably is larger or more massive than the radiating element. The antenna ground preferably has at least one dimension that is about three (3) to about four (4) times larger than the respective dimension of the radiating element. In addition, the floating ground plane preferably is larger, preferably dimensionally larger, or more massive than the radiating element, and the floating ground plane preferably is larger, preferably dimensionally larger, or more massive than the antenna ground.

In yet another embodiment, the circularly polarized antenna includes a planar conductive radiating element and a conductive antenna ground, wherein the floating ground plane, radiating element and antenna ground are sized and located so that the radiating element is spaced and electrically isolated from the antenna ground and the floating ground plane, and the antenna ground is spaced from and electrically isolated from the radiating element and the floating ground plane. This configuration and arrangement assists the antenna with achieving acceptable VSWR to effectively propagate a signal. The antenna system may further include a signal coupler, wherein the signal coupler comprises the antenna ground. The signal coupler ground preferably is electrically connected to the antenna ground or forms the antenna ground and is preferably electrically isolated from the radiating element and the floating ground plane. The floating ground plane preferably is connected to the ground of the wireless device. The antenna system may be used in a portable wireless device, a handheld portable wireless device, a moveable vehicle and/or a stationary device.

The floating ground plane in exemplary embodiments may be about 0.5 centimeters to about 125 centimeters in length, about 0.5 centimeters to about 125 centimeters in width or height, and relatively thin, although other sizes and shapes are contemplated and will work. Generally the larger the floating ground plane the better the operation of the antenna. In one exemplary embodiment, the circularly polarized antenna includes a conductive planar shaped radiating element and an antenna ground, and the floating ground plane may be located and positioned about one (1) mm to about thirty (30) mm from the antenna, preferably from the antenna ground; more preferably about two (2) mm to about ten (10) mm from the antenna, preferably the antenna ground, depending upon the operating power of the wireless system. Generally, the closer the distance the floating ground plane is to the antenna without arcing or shorting, the better the performance of the antenna system. The radiating element in exemplary embodiments may have a length of about 25 mm to about 250 mm and a height or width of about 20 mm to about 180 mm, and the antenna ground may have a length of about 115 mm to about 990 mm and a height or width of about 55 mm to about 990 mm, and a relatively thin thickness, such as, for example, about one (1) mm to about two (2) mm, although other dimensions and shapes are contemplated and will work and to a large extent is determined by operating frequency, operating power and packaging limitations.

A method of improving an antenna system of a wireless device is also disclosed comprising the steps of (a) providing a circularly polarized antenna; and (b) inductively coupling the circularly polarized antenna to a floating ground plane to improve the performance of the antenna system. The method may further comprise the step of providing a floating ground plane and placing the floating ground plane in proximity to and preferably isolated from and not in physical or electrical contact with the circularly polarized antenna to inductively couple the antenna to the floating ground plane. The method may still further include the step of mounting the floating ground plane to or within the housing or platform of the wireless device.

The circularly polarized antenna may have a conductive planar-shaped radiating element and the method may further comprise the step of configuring the floating ground plane to be larger or more massive than the radiating element. The method may further comprise the circularly polarized antenna having a conductive planar-shaped antenna ground and further comprising the step of configuring at least one dimension of the antenna ground to be larger than, preferably about three (3) to about (4) times larger than, the respective dimension of the radiating element.

A method of improving an antenna system is also provided wherein a circularly polarized antenna having a conductive planar shaped radiating element and antenna ground, and a floating ground plane is provided, and the proportional size and relative spatial distances between the floating ground plane, the radiating element and the antenna ground are configured to inductively couple the floating ground plane to the antenna and achieve an acceptable VSWR to effectively propagate a signal. The radiating element, antenna ground and floating ground plane may be configured and arranged to obtain a Voltage Standing Wave Ratio (VSWR) at a desired frequency band of less than 3:1, and more preferably less than 2:1.

In yet another aspect of the invention, one or more power amplifiers optionally may be connected to the circularly polarized antennas and may also be connected to the ground of the wireless device. The floating ground plane may be in proximity to the ground of the optional power amplifier, and in one example, may be approximately 1 millimeter to about 1 centimeter to the ground of the power amplifier. It should be noted that each of the features described herein may be used separately or multiple features may be combined together in a single device, system or application.

In a further aspect and embodiment of the invention, which has particular application to hand held and other wireless devices where the human body may interfere with reception or transmission of the signal by physical contact or interference occurring between the wireless device and the hand, ear, or other body parts of a user that may attenuate the antenna signal, such as, for example, in a mobile or wireless phone, it has been found advantageous to capacitively couple the user to the device and/or floating ground plane. This wireless device preferably has a housing, preferably a hand-holdable housing, that comprises an antenna, preferably a circularly polarized antenna, for transmitting or receiving a signal, an optional power amplifier connected to the antenna and connected to the ground of the wireless device, and a floating ground plane, wherein the floating ground plane is in proximity to the antenna, preferably the ground of the antenna, so that the floating ground is inductively coupled to the antenna.

The floating grounding plane may comprise one of a strip, band, foil, mesh, plate, block, coating or sheet of conductive metal and may be a relatively thin copper strip. Other forms for the floating ground plane are contemplated. The conductive strip in one embodiment may be about 0.5 centimeters to about 1.5 centimeters in length and about 2.5 centimeters to about 3 centimeters in width or height. In one embodiment the floating ground plane is located a distance of about five (5) millimeters to about eight (8) millimeters from the antenna and preferably inductively couples to the antenna, preferably the ground of the antenna.

In yet another embodiment for “hand holdable” applications, the floating ground plane preferably is connected to the housing or metallic elements on the exterior of the device housing where a user preferably physically contacts the metallic elements on the housing to capacitively couple the user to the wireless device so that the user becomes part of the antenna. By placing a dedicated or floating grounding plane, such as, for example, a strip, band, foil, mesh, plate, block, coating or sheet of metal, in the device and inductively coupling the floating grounding plane (e.g., metal strip) to the antenna by placing it in proximity to the antenna, and connecting the floating grounding plane (e.g., metal strip) to at least a portion of the housing where the user makes physically contact, the user can be coupled to the antenna and become part of the overall antenna radiating system. The floating ground plane may be connected to the housing or metallic elements on the housing preferably by coaxial cable.

In the Apple iPhone 4, for example, the metal band around the phone may serve as the ground plane and allow the user to be coupled to the phone's antenna and become part of the overall antenna radiating system, rather than have the metal band assist in grounding out or shorting the wireless (e.g. electromagnetic) signals. The results have been experimentally proven with very positive results. The transmission with the improved antenna system has a much higher equivalent isotropically radiated power (EIRP), sometimes referred to as gain, with increases from 33% of power transmitted to >95% of transmitted power radiated. The antenna preferably does not short out by the user holding the phone in any position.

In a further embodiment, the floating ground plane may be connected to the ground of the wireless device. In yet another aspect of the invention, the floating ground plane is in proximity to the ground of the power amplifier, and in one example may be approximately one (1) millimeter to about one (1) centimeter to the ground of the power amplifier. It should be noted that each of these features may be used together or separately.

The antenna system in still a further embodiment may have a coaxial cable that connects the antenna to the power amplifier. In an embodiment the length of the coaxial cable connecting the antenna to the power amplifier is selected to match the impedance of the antenna to the impedance of the power amplifier. The coaxial cable that connects the power amplifier to the antenna preferably has a length greater than or equal to about 0.15 of the effective corrected wavelength of the antenna. In one representative example the coaxial cable extending between the power amplifier and the antenna is about one (1) centimeter to about one and a half (1.5) centimeters in length.

In yet another example of the present invention, the antenna system further comprises a coaxial cable extending from the lead connecting the power amplifier to ground toward the floating ground plane, and the end of the coaxial cable is preferably no more than ten (10) mm from the floating ground plane. The length of the coaxial cable extending toward the floating ground plane may be about one and a half (1.5) centimeters to about three and a half (3.5) centimeters long and preferably as short as possible to reduce losses. Other lengths for the coaxial cable extending toward and in proximity to the floating ground plane from the lead that connects the power amplifier to ground is contemplated.

In a further embodiment of the invention which advantageously reduces a user's exposure to the radiation effects of the wireless device, particularly the radiation exposure to the head of the user, an antenna and a floating ground plane is provided, preferably a circularly polarized antenna and a conductive floating ground plane, whereby the floating ground plane is positioned and configured to inductively couple the floating ground plane to the antenna and the user is capacitively coupled to the wireless device by contacting the floating ground plane or a conductive member or conductive contact electrically connected to the floating plane so that the user becomes part of the antenna. It is believed that when the user is coupled to the antenna and becomes part of the antenna, there is less concentration of the electromagnetic signal at the head and/or ear of a user and that the signal is propagated away from the head. It is believed that in this embodiment, the direction of propagation of the signal is changed and directed away from the head of the user. In one embodiment, the floating ground plane is positioned and configured to lie substantially over and preferably cover entirely one side of the antenna. It is believed that the electromagnetic waves transmitted by the wireless device are propagated and dispersed away from the user by the floating ground plane. For example, in a wireless or mobile phone, the antenna and the floating ground plane may be positioned advantageously closer to the (back) side of the phone that is away from the user, and the user of the wireless or mobile phone preferably handles the phone so that the other opposite (front) side is directed toward their body. The floating ground plane preferably substantially or entirely covers, overlies or overlaps the area of the antenna so that the electromagnetic waves are believed to be propagated away from the user. In one embodiment the antenna components of the circularly polarized antenna preferably comprising the radiating element and the antenna ground are formed on a first or front side of a printed circuit board and a metallic sheet, foil or plate is placed over and substantially covers the majority of the second or back side of the printed circuit board, and the printed circuit board assembly is positioned in the wireless device toward the back side of the wireless device and preferably over the battery pack so that the antenna components face the battery pack and the front of the housing.

An optional audio output device, e.g., a speaker, may be located in the mobile or wireless device preferably between the floating ground plane and the front side of the device, and preferably located so as to transmit sound toward the first side, while the floating ground plane protects the user from exposure to electromagnetic radiation transmitted and received by the antenna of the wireless device by propagating the signal away from the user, and dispersing and distributing the signal over the entire user as the user becomes part of the antenna system.

### BRIEF SUMMARY OF THE DRAWINGS

The foregoing summary, as well as the brief description of the preferred embodiments will be better understood when read in conjunction with the appended drawings. For the purpose of illustrating the preferred embodiments of the present inventions, and to explain their operation, drawings of the preferred embodiments and schematic illustrations are shown. It should be understood, however, that the application and invention is not limited to the precise arrangements, variants, structures, features, embodiments, aspects, methods and instrumentalities shown, and the arrangements, variants, structures, features, embodiments, aspects, methods and instrumentalities shown and/or described may be used singularly in the device, system or method or may be used in combination with other arrangements, variants, structures, features, embodiments, aspects, methods and instrumentalities. In the drawings:

FIG. 1 is a schematic illustration of the antenna system in a current cordless phone;

FIG. 2 is a schematic diagram of a preferred embodiment of the antenna system of the present invention as implemented in a wireless device;

FIG. 3 is a schematic illustration of a circularly polarized antenna for use in the wireless device of FIG. 2;

FIG. 4 is a plan view of a circularly polarized antenna that may be used in an embodiment of the antenna system according to the invention;

FIG. 5 is a plan view of a circularly polarized antenna that may be used in an embodiment of the antenna system according to the invention;

FIG. 6 is a plan view of one embodiment of an antenna for use in the improved antenna system of the present invention;

FIG. 7 is a side view of the antenna of FIG. 6;

FIG. 8 is a top perspective view of another embodiment of a circularly polarized antenna that may be used in an embodiment of the antenna system of the present invention;

FIG. 9 is a bottom perspective view of the antenna of FIG. 8 with a signal coupler attached;

FIG. 10 is a perspective view of another embodiment of a circularly polarized antenna that may be used in an embodiment of the antenna system according to the present invention;

FIG. 11 is a perspective top view of a robot system that is wirelessly controlled which utilizes an embodiment of the antenna system of the present invention;

FIG. 12 is a side view of the robot device used in the robot system of FIG. 11;

FIG. 13 is the VSWR test results of an embodiment of the antenna system of the present invention from 1.5 GHz to 2.8 GHz;

FIG. 14 is the gain of the antenna system used in the robot device of example 1;

FIG. 15 is the VSWR test results of another embodiment of the antenna system of the present invention from 1 GHz to 3 GHz;

FIG. 16 is the gain of the antenna system used in the robot device of example 2;

FIG. 17 is a side view of another embodiment of the antenna system of the present invention mounted on a vehicle;

FIG. 18 is the VSWR test results of one embodiment of the antenna system of the present invention mounted on a vehicle from 100 MHz to 400 MHz;

FIG. 19 is the VSWR test results of the antenna system of FIG. 18 from 0.5 GHz to 1 GHz;

FIG. 20 is the predicted gain of one embodiment of the antenna system used on the vehicle of example 3;

FIG. 21 is a top perspective view of another embodiment of the antenna system according to the present invention used on a wireless device;

FIG. 22 is a schematic diagram of an embodiment of the antenna system of the present invention advantageous used in hand-holdable wireless devices;

FIG. 23 is a schematic diagram of an embodiment of an antenna system of the present invention;

FIG. 24 is a schematic diagram of another embodiment of an antenna system of the present invention;

FIG. 25 is a schematic diagram of still a further embodiment of an antenna system of the present invention;

FIG. 26 is a cross-sectional representation of still another embodiment of a wireless communication device, for example a mobile phone, implementing an improved antenna system of the present invention which capacitively couples the user to the wireless device and reduces radiation exposure from wireless communication devices;

FIG. 27 is a back view of the mobile phone of FIG. 26 with the back cover removed illustrating the placement of the new antenna system;

FIG. 28 is a back view of the mobile phone of FIG. 26 with the back cover removed and the antenna system tilted to show the configuration of the antenna;

FIG. 29 is a view of the mobile phone of FIG. 26 with the antenna system installed in the back cover before its placement on the body of the mobile phone;

FIG. 30 is a perspective side view of the mobile phone of FIG. 26 with the antenna installed inside the housing and a portion of the floating ground plane extending to the exterior of the housing;

FIG. 31 is a plot of the gain of the antenna used in the mobile phone of FIG. 26 where no hands contact the mobile phone; and

FIG. 32 is a plot of the gain of the antenna of FIG. 26 where hands are used to contact the mobile phone during its use.

### DETAILED DESCRIPTION OF THE PREFERRED EMBODIMENTS OF THE INVENTION

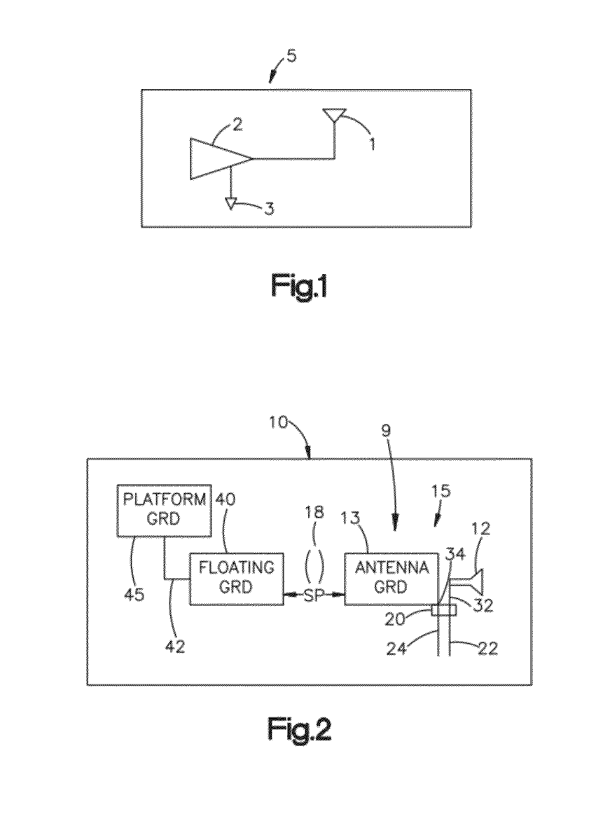

While the present invention may be implemented by a number of means and configurations, for illustrative purposes certain preferred embodiments of an antenna system are shown in FIGS. 2-32 for improving the gain, or EIRP, of a device used to transmit and/or receive signals, in order to provide improved range. The antenna system of the present invention should not be limited to the embodiments shown. The description herein is directed to a person skilled in the art of antenna design and radio frequency (RF) communications. The antenna system may be used in any type of wireless device, including but not limited to mobile, cellular or wireless phones, computers, tablets, ipods, pagers, global positioning satellite (GPS) devices, radios, televisions, WiFi devices, wireless routers, Bluetooth enabled devises, radio frequency controllers, robots, RF controlled vehicles, and on and in moveable vehicles, stationary devices and with other wireless devices.

As shown in FIG. 1, a typical transmitting, receiving or transceiver device 5, such as, for example, a wireless phone, uses a linear dipole antenna 1 connected to a power amplifier 2 that is connected to ground 3. This device 5 will incur some of the detuning and grounding effects described in the Background section of this application.

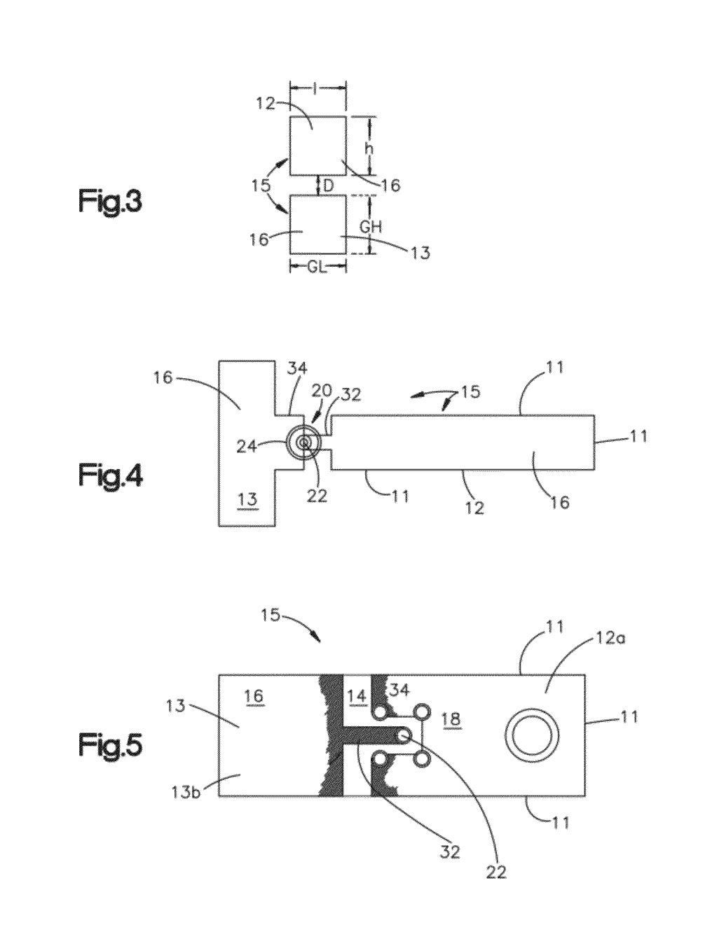

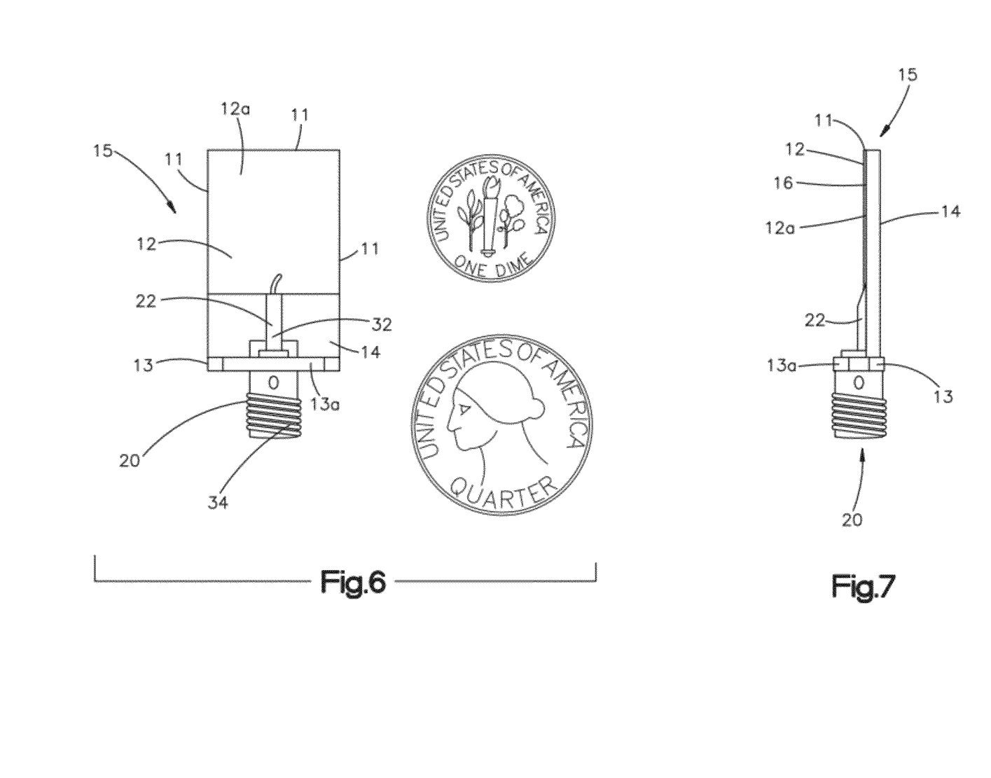

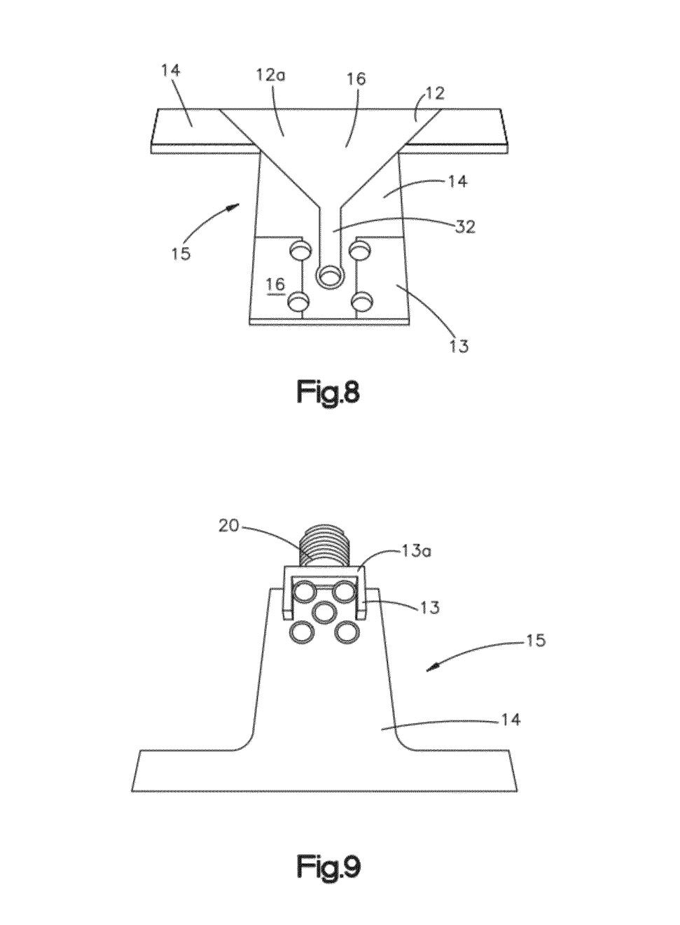

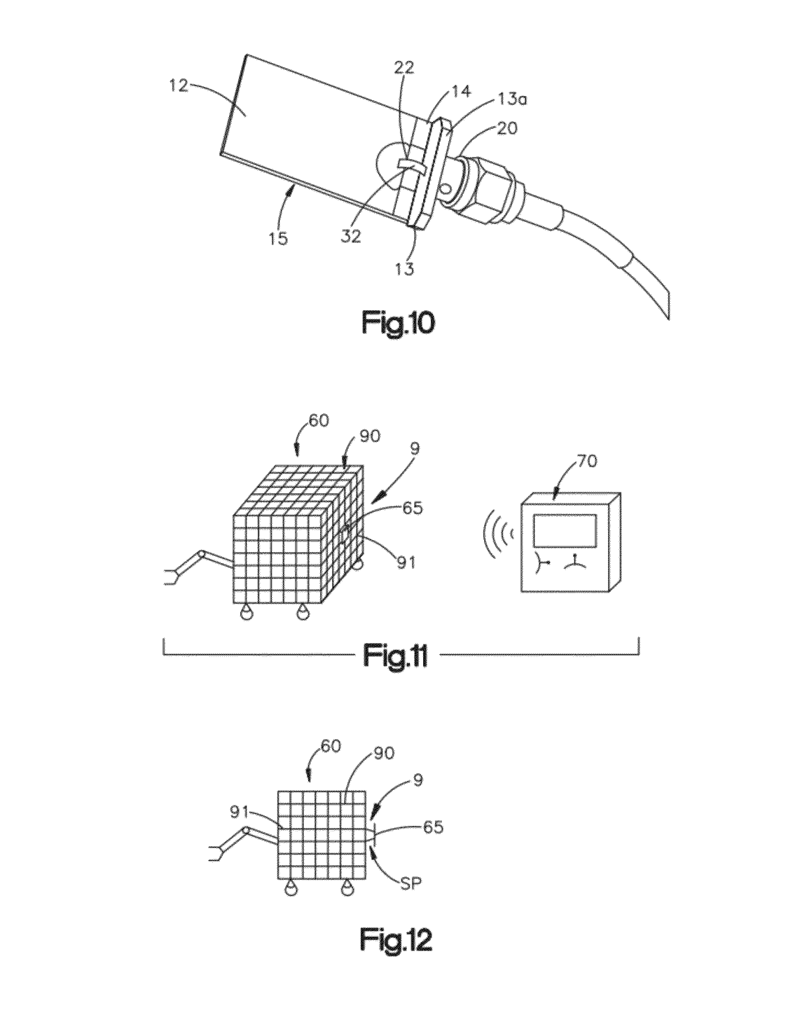

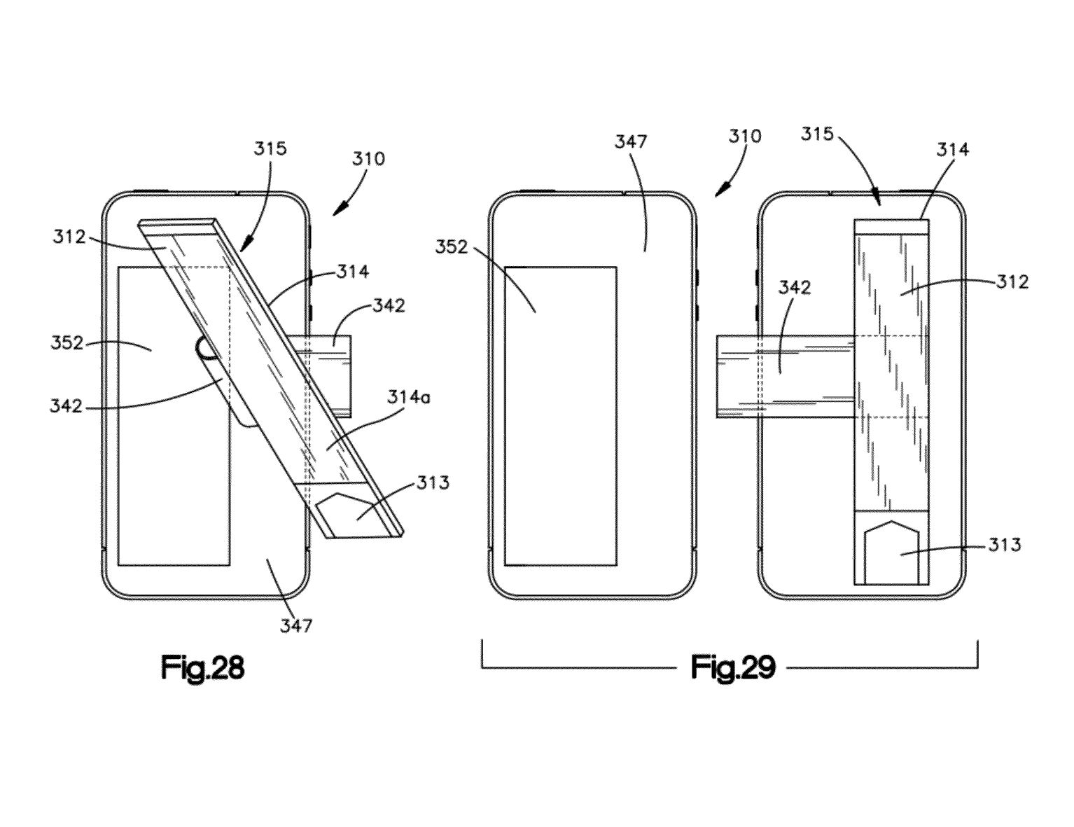

As shown in the schematic representation in FIG. 2, a wireless transmitting, receiving or transceiver device 10, such as, for example, a robot that is wirelessly controlled, preferably uses one or more circularly polarized antenna 15. FIG. 3 shows a schematic illustration of an embodiment of a circularly polarized antenna 15, FIG. 4 shows a plan view of another embodiment of a circularly polarized antenna 15, and FIG. 5 shows another circularly polarized antenna 15 that may be used in an embodiment of the present antenna system. FIGS. 6 and 7 of the present application also show the design of a circularly polarized antenna 15 that has worked in a 1.9 GHz cordless phone. The antenna of FIGS. 6 and 7 was configured for 1.9 GHz and is shown next to a United States quarter and dime to provide approximate, relative dimensions. FIGS. 8 and 9 show another embodiment of a circularly polarized antenna with FIG. 9 showing a signal coupler 20 to deliver or receive a signal. FIG. 10 shows yet another embodiment of a circularly polarized antenna 15 that is similar to the antenna of FIGS. 6 and 7. Yet another circularly polarized antenna is shown in FIG. 28. The size and shape of the antennas 15 generally would vary depending upon the frequency band at which the antenna is intended to work.

Each antenna 15 may comprise a radiating element 12 and an antenna ground 13 as schematically illustrated in FIG. 2. The radiating element 12 preferably is formed of conductive material 16, for example, copper, but other conductive materials will work and are contemplated for radiating element 12. Radiating element 12 is preferably formed as a thin sheet, strip, band, foil, mesh, plate or coating having a length l, a height h or width w, and a thickness t on insulating substrate 14. The thickness of the radiating element 12 in one embodiment preferably is relatively small compared to its length and height or width. Representative thickness of the radiating element range from about one (1) mm to about two (2) mm, although other values are contemplated and will work. The radiating element 12 is preferably planar and flat shaped, although it may be curved and take other forms and shapes. In one embodiment, the radiating element may be square or rectangularly-shaped as shown in FIG. 3-6, although it may take other forms. The radiating element 12 may comprise a coating 12a on a substrate 14 that was manufactured using printed circuit board technology. The radiating element 12 is formed preferably so that it radiates along its edges 11 and preferably the conductive material 16 extends to the edges of the printed circuit board. In a preferred embodiment, the printed circuit board substrate (the dielectric/insulating material) 14 may be formed with chamfered, beveled or rounded edges and the conductive coating 16, usually copper, forming the radiating element 12 extends over the chamfered, beveled or rounded edges. Antenna radiating element 12 may be disposed on one or both sides of the insulating substrate 14. The radiating element 12 may have a further coating or sheet (not shown) of insulating, dielectric or less conductive material over it. The insulating or dielectric coating or sheet over the radiating element 12 may serve to protect the radiating element 12.

The antenna ground 13 is also preferably formed of conductive material 16. The conductive material 16 used for the radiating element 12 may be different than or the same as the conductive material 16 used for the antenna ground 13. The antenna ground 13 preferably is isolated a distance d from the radiating element 12. The radiating element 12 and antenna ground 13 may be disposed on the same substrate 14 as shown in FIG. 5 and both may be a coating of conductive material, for example copper, preferably in one embodiment formed on an insulating substrate 14 using printed circuit board technology. Preferably, the radiating element 12 and antenna ground 13 are formed on a planar shaped insulating substrate 14 extending in a principal plane as shown in FIG. 5. The antenna ground 13 may be formed as a thin planar sheet, strip, band, plate, foil, or coating 13b, and may be formed on the same substrate 14 as the antenna radiating element 12. Examples of the thickness of the antenna ground range from about one (1) mm to about two (2) mm, although other thickness values are contemplated and will work. The ground antenna 13 also may take other forms such as, for example, the plate 13a as shown in FIGS. 6-7 and 10, and may be connected to or part of and integral with the exterior of a signal coupler. In one embodiment the antenna ground 13 may be square or rectangularly shaped as shown in FIGS. 3-5 having a height GH, a length GL, and a thickness GT.

The circularly polarized antenna 15 may be a circularly polarized dipole-like antenna that has an asymmetric dipole design. Additional circularly polarized antenna designs that will work with device 10 include the antennas shown and described in U.S. Pat. No. 7,733,280, the entire contents of which are incorporated herein by reference, including the antenna design of FIGS. 1-6 of U.S. Pat. No. 7,733,280. In one embodiment the circularly polarized antenna 15 has the design of FIG. 4 of U.S. Pat. No. 7,733,280. The circularly polarized antenna 15 may include plural antennas sharing a common ground bus as shown in FIG. 4 of the '280 patent or may comprise only one radiating element and one antenna ground as shown in FIG. 4 of this application. The circularly polarized antenna may also be configured like FIGS. 1-3 or FIGS. 5 and 6 of U.S. Pat. No. 7,733,280.

Antenna 15 further may include a signal coupler 20, diagrammatically illustrated in FIG. 4, having a first signal conductor 22 and a second conductor 24. The first signal conductor 22 of the coupler 20 is coupled through a first feed portion 32 to the radiating element 12, and the second conductor 24 of the coupler 20 is coupled through a second feed portion 34 to the antenna ground or ground conductor 13. In operation, applied RF signal currents fed through coupler 20 pass through feed portions 32, 34 into radiating element 12 and the antenna ground (ground conductor) 13, respectively. From there, electric fields extend between the antenna ground 13 and the radiating element 12 in such a way to cause the RF signals to radiate from the antenna 15, and preferably from the edges 11 of the radiating element 12.

The size and shape of the radiating element 12 is varied to meet frequency requirements and impedance matching according to “patch radiator” technology. The size and shape of the feed portions 32, 34 preferably match impedances from the coupler 20 to the radiating element 12 of the antenna 15. Generally, the higher the frequencies the smaller the size of the radiating element 12. In addition, while the antenna ground 13 may be roughly the same size as the size of the radiating element 12 of the antenna as shown in FIGS. 3 and 5, other relative sizes for the antenna ground 13, as shown in FIGS. 4, 6-10 and 28 are contemplated, and it is preferred in some embodiments that the antenna ground 13 be larger than or more massive than the radiating element 12. In one embodiment, it is preferred that at least one dimension of the antenna ground 13 be about three (3) to about four (4) times larger than the respective dimension of the radiating element 12. In addition, multiple radiating elements 12 and a single antenna ground 13 may be formed on the same insulating board 14 as shown in FIG. 4 and FIG. 28.

RF signals, including high frequency signals, Very High Frequency signals, microwaves and other radio frequency signals, may be feed or delivered to or received from antenna 15. The antenna 15 has been described as a transmitting antenna where signals are fed to the antenna 15, but the same principals, connections and spatial and geometric relationships apply if the antenna 15 is a receiving antenna, or both a transmitting and receiving antenna (for a transceiver device).

In addition, as shown schematically in FIG. 2, the device 10 may include a dedicated or floating grounding plane 40. The floating ground plane 40 preferably may be electrically connected by a lead or other connection 42 to the ground 45 of the device or platform 10. The floating ground plane 40 preferably is a conductive material and may take the form of a metal strip, band, foil, mesh, thin sheet, coating, plate or block, but is not limited to these embodiments or forms. The floating grounding plane 40 preferably has some mass and size, with the mass and size preferably being varied depending upon the application and to impedance match with the one or more antennas 15. Preferably the floating ground plane 40 may be copper, gold, aluminum, steel, sheet steel, iron or other conductive metals. The floating ground plane preferably is generally a flat planar surface but is not limited by its shape to a planar structure or surface, or having a flat or planar surface. The floating ground plane can take the form of shapes and have curved surfaces. In addition, while it is preferred that the floating ground plane 40 be larger or more massive than the antenna ground 13, and that the floating ground plane 40 also preferably be larger or more massive than the radiating element 12, the floating ground plane 40 does not have to be larger or more massive than the antenna ground 13 or radiating element 12. In one embodiment the floating ground plane 40 is larger than the antenna ground 13 and larger than the radiating element 12, which may be advantageous and facilitate achieving acceptable VSWR to effectively propagate signals of a desired frequency bandwidth. Preferably the antenna has a VSWR at the desired frequency of less than 3:1, preferably less than 2:1.

The floating grounding plane 40 preferably is in close proximity to, but not in electrical contact with, the antenna 15, and in particular, in close proximity to, but not in electrical contact with the antenna ground 13 to inductively couple the floating ground plane 40 to the antenna 15, and in particular, to inductively couple the floating ground plane 40 to the antenna ground 13. The inductive coupling of the floating ground plane 40 to the antenna 15, and particularly the antenna ground 13 is schematically illustrated in FIG. 2 by 18. For the antenna system to operate in its preferred manner, the circularly polarized antenna, such as, for example, one of the designs shown in FIG. 3-10 or 28, should be inductively coupled to the floating ground plane 40 by spatially setting up the proper distances between the floating ground plane 40 and the antenna ground 13. The floating ground plane 40 preferably is placed in proximity to but is electrically isolated from the antenna ground 13.

The distance between the floating ground plane 40 and the antenna 15 may vary by the device, application and packaging requirements. The spatial distance SP between the floating ground plane 40 and the antenna ground 13 to obtain inductive coupling and the best desired results will depend upon the application, including the frequency of operation of the wireless device (and in particular the antenna at issue), the packaging limitations (e.g., the size of the housing of the wireless device 10), the size of the floating ground plane 40 (e.g., the mass and physical dimensions), the operating power, and the arrangement of other circuitry and power supply elements (including any batteries). Generally, the larger the size and mass of the floating ground plane 40, the further the antenna ground 13 may be from the floating ground plane 40 and still be inductively coupled to the floating ground plane 40. In addition, the higher the power of the device, the larger the distance SP that the floating ground plane 40 may be from the ground 13 of the antenna 15 and still be inductively coupled to the antenna, and the larger the distance SP that the floating ground plane 40 should be from the antenna to prevent grounding out the antenna. Preferably, the floating ground plane 40 should be located as close as possible to the antenna 15 without arcing or shorting between the antenna 15 and floating ground plane 40. Representative values for the distance SP that the floating ground plane may 40 be located from the antenna 15 include about one (1) millimeter or so, to a couple of centimeters, to a couple of inches, although other distances are contemplated and depend upon the operating power of the wireless system, the packaging, the operating frequency of the antenna(s) and the application as discussed herein.

Preferably, the floating ground plane 40 is closer to the antenna 15 than to the ground 45 of the device 10. The floating grounding plane 40 being closer to the antenna 15 is typically more important than the floating grounding plane 40 being closer to the ground 45 of the device 10.

Factors that influence the size of the floating ground plane 40 include the frequency that the antenna operates at, the power that the antenna radiates at and has to handle (higher power generally requires a larger floating ground plane), and the proximity of the floating ground plane to the ground 13 of the antenna 15 (larger floating ground plane can be placed at a larger distance from the antenna ground 13).

It is believed that by inductively coupling the floating ground plane 40 to the antenna 15, the platform or device 10 becomes part of the radiating element of the antenna 15. Inductively coupling the circularly polarized antenna 15 to the floating ground plane 40 has resulted in superior antenna performance including a much higher equivalent isotropically radiated power (EIRP), sometimes referred to as gain, with increases from 33% of power transmitted to >95% of transmitted power radiated. In addition, the Voltage Standing Wave Ratio (VSWR) of the antenna system used in a system where the floating ground plane 40 is inductively coupled to the circularly polarized antenna 15 has been better than 2:1, and the range of the antenna system has been better than six times the typical dipole antenna system. Further, in high frequency wireless devices, such as, for example, devices that transmit and receive signals at 1.2 GHz, 2.4 GHz and 5.8 GHz, when inductively coupling a floating ground plane as described herein with a circularly polarized antenna as described herein, the radiation and reception pattern for the antenna system becomes substantially omni-directional. Such circularly polarized antenna systems described above are no longer straight line of sight reception and transmission antenna and are not obstructed by buildings or other obstructions between the transmitting and receiving antenna systems.

The size of the floating ground plane 40 and its proximity to the antenna 15 effects the VSWR of the antenna system. Generally the larger or more massive the floating plane 40 the better the antenna performance and VSWR. In addition, the closer the floating ground plane is to the antenna without arcing or shorting, the better the performance of the antenna and the better the VSWR. The length of the cable (feed signal 32) feeding the radiating element 12 also effects the VSWR of the antenna system. Generally the signal feed cable to the radiating element 12 should be short to reduce signal losses in the feed cable and should also be sized for impedance matching with the antenna 15.

### Example 1

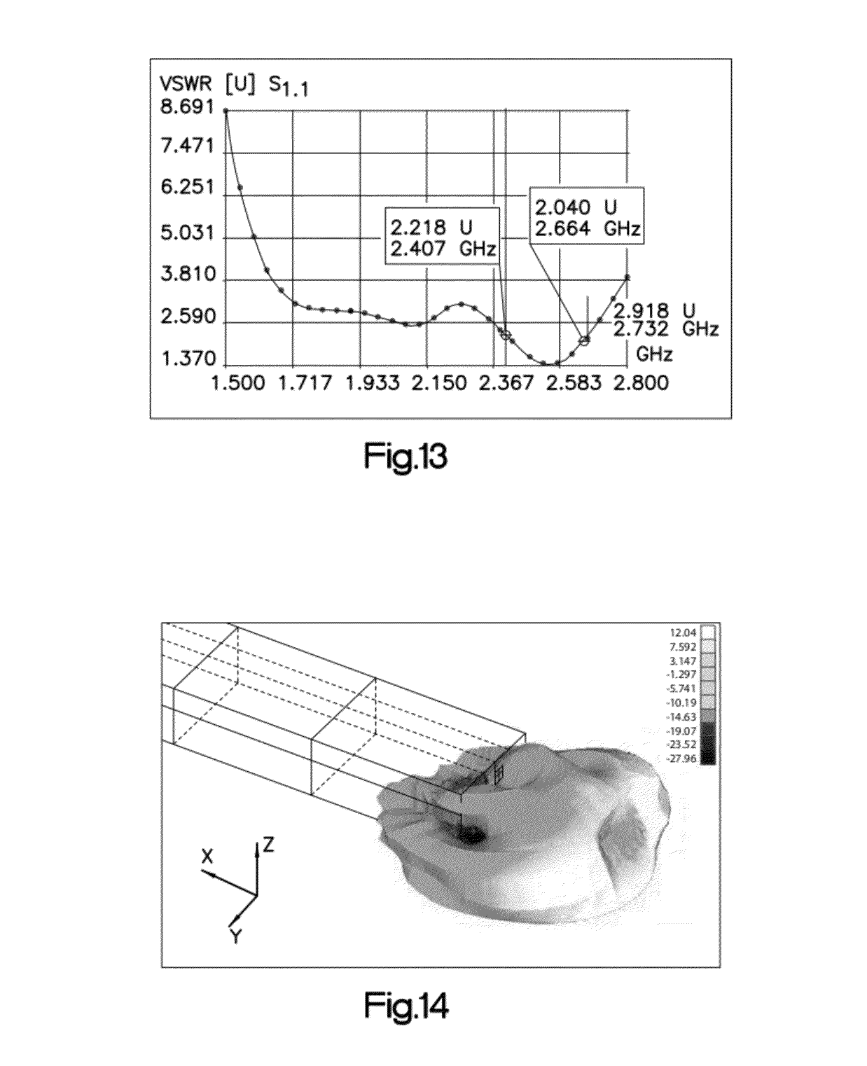

An Example of a practical application of the antenna system 9 of FIG. 2 for a wirelessly controlled robot 60 is shown in FIGS. 11 and 12. The wirelessly controlled robot 60 includes a circularly polarized antenna 65. The design of antenna 65 is schematically illustrated in FIG. 3 and shown generally in FIG. 5 wherein the radiating element 12 is approximately 25 mm in length l and about 20 mm in height h or width, while the antenna ground 13 is about 115 mm in length GL and about 55 mm in height GH or width, with the radiating element 12 being separated from the antenna ground 13 by about 5 mm (d about 5 mm). The radiating element 12 and antenna ground 13 are formed on the same circuit board or insulating substrate 14, where both the radiating element and antenna ground are relatively flat, thin, planar surfaces oriented in the same plane. In one embodiment, the antenna 65 is mounted about 12.5 mm behind the robot 60 (SP about 12.5 mm), and in this example behind the vertical plane of the robot, and about 1 meter from the ground. The antenna 65 is mounted to the robot platform 60 so that it is electrically isolated from the robot platform 60, preferably using non-conductive supports. Care should be taken when mounting the antenna 65 on the robot platform as the robot batteries may adversely affect the performance of the antenna. The robot antenna 65 receives signals to control the movement and action of the robot at 2.441 GHz frequency band and has a video link to send video images back to the user at a 2.556 GHz frequency band. One antenna 65 preferably is used on the robot to transmit and receive both the 2.441 GHz and 2.556 GHz frequency bands.

A floating ground plane 90 is added to the robot platform 60, and in this embodiment the floating ground plane 90 takes the form of copper mesh 91 wrapped around the exterior of the robot and physically electrically connected to ground of the robot platform 60. The power of the wireless control system in the robot platform 60 and in the wireless controller 70 is about two to about four watts, and with the antenna 65 of the robot mounted 12.5 mm behind the robot 60 and thus about 12.5 mm from the copper mesh 91 or floating ground plane 90, the floating ground plane 90 is believed to be inductively coupled to the antenna 65. It is believed that under these conditions the robot platform 60 becomes part of the antenna system as shown by FIG. 14. When the floating ground plane 90 is inductively coupled to the circularly polarized antenna 65 of the robot platform 60, the antenna system 9 operates substantially as an omni-directional antenna that transmits 2.556 GHz for the video link and receives 2.441 GHz signals to control the robot movement. In addition, the antenna system is no longer a straight line of sight communication system. As a result the antenna and communications system preferably is no longer influenced or is not as influenced by interference caused by obstructions.

The same antenna 65 preferably is also used in the wireless controller 70 for the robot, although other circularly polarized antenna designs, as well as other designs, including standard dipole antenna designs, may be used. The antenna in the wireless controller unit 70 may be mounted inside the controller housing or outside the controller housing, but care should be taken to keep the batteries from adversely effecting the performance of the antenna system. To obtain optimum results, it is preferred to provide a floating ground plane in proximity to the antenna, preferably a circularly polarized antenna, in order to inductively couple the antenna to the floating ground plane.

FIG. 13 shows the VSWR from 1.5 GHz to 2.8 GHz for the robot 60 when utilizing the circularly polarized antenna 65 as described, while FIG. 14 shows the robot antenna gain at 2.441 GHz. The VSWR in FIG. 13 is better than 2:1 from 2.4 to 2.65 GHz. It should be noted that with the antenna mounted at the back of the robot 60 the gain is maximized behind the robot for maximum range. In FIG. 14, the gain behind the robot antenna is in a range roughly of −10 db to −20 db, the midsection has a gain of −3 db to 10 db, and the front has a gain of roughly +12 db to +1 db. The gain pattern of FIG. 14 shows how the robot itself has become part of the antenna system.

### Example 2

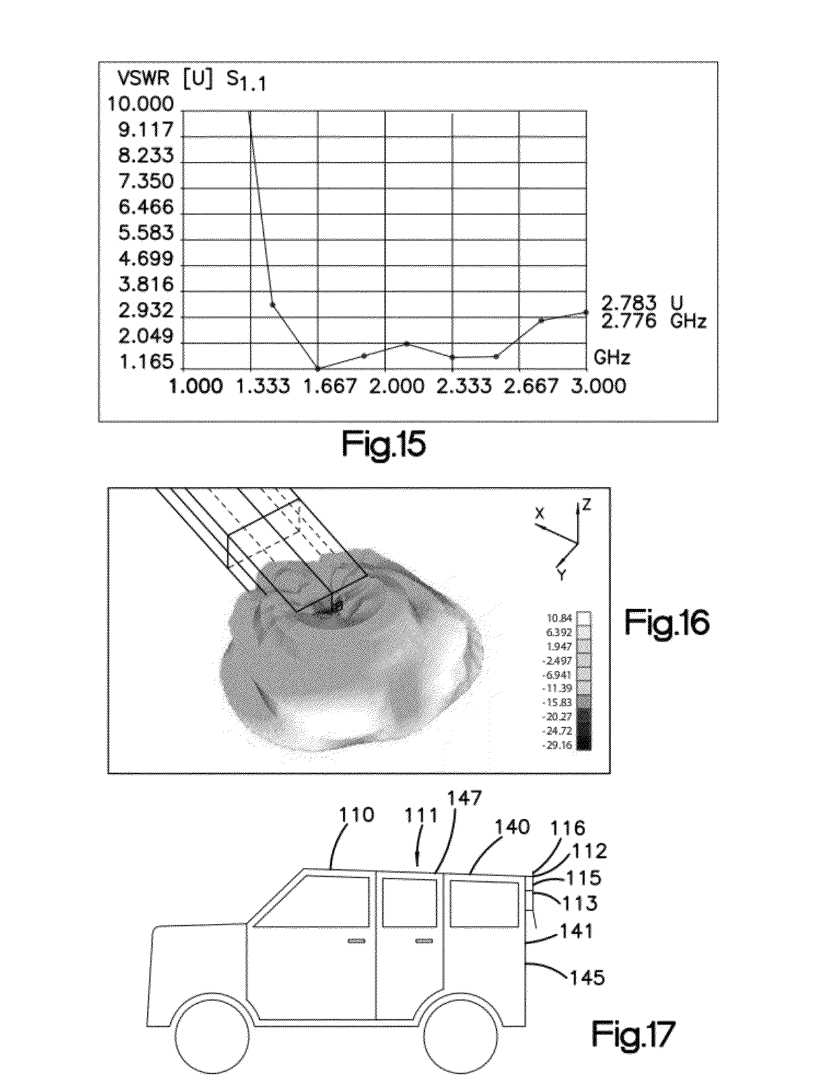

In another example, the same CP antenna 65 as used in the first example on the robot platform 60 was used on the same robot platform but the antenna 65 was mounted 25.4 mm (about 1 inch) behind the robot, e.g., behind the vertical plane of the robot and thus about 25.4 mm from the floating ground plane 90 or wire mesh 91. Again the antenna 65 preferably is mounted to the robot platform 60 so that it is isolated from and not electrically connected to the platform 60. The VSWR for the robot 60 with the CPA antenna 65 mounted 25.4 mm behind the robot (i.e., 25.4 mm from the floating ground plane) is shown in FIG. 15, while the antenna gain at 2.556 GHz is shown in FIG. 16. For the robot 60 with the CPA antenna 65 mounted 25.4 mm from the robot platform (the copper mesh), the VSWR is better than 2:1 from 1.6 GHz to 2.65 GHz as shown in FIG. 15. It should be noted that with the antenna mounted in the back of the robot 60, the gain is maximized behind the robot with the gain ranging roughly from −3 db to −8 db in the back to roughly −3 db to +10 db in the front as shown in FIG. 16. The gain pattern of FIG. 16 shows how the robot has become part of the antenna system.

### Example 3

In another example, an antenna 115 schematically illustrated as in FIG. 3, and similar in layout to FIG. 5, has a radiating element 12 having a length l of about 250 mm, and a height h or width of about 180 mm, separated a distance d of about 5 mm from antenna ground 13 is utilized. The antenna ground 13 has a length GL of about 990 mm and a height GH or width of about 990 mm. Both the radiating element 12 and antenna ground 13 are formed on a printed circuit board using printed circuit board technology. Thus, both the radiating element and the antenna ground are formed as thin metal foils or conductive coatings on an insulating substrate 14. Both the radiating element 12 and antenna ground 13 are relatively flat, thin, planar surfaces oriented in the same plane. Circularly polarized antenna 115 is mounted on a moveable vehicle 110 as shown in FIG. 17. The antenna 115 is mounted about an inch behind the vehicle 110. Preferably the antenna is mounted so that it is electrically isolated from the skin of the vehicle. In this example, the skin 141 of the vehicle 110 is formed of sheet steel and is connected to the ground of the vehicle. In addition, as the vehicle is mounted on rubber tires the vehicle is isolated from earth ground. In this exemplary embodiment the antenna 115 is operated at about one hundred and fifty (150) watts. The skin 91 of the vehicle, being formed of a conductive material, becomes the floating ground plane 140 for the antenna system 111. The antenna 115 is isolated from and mounted about one (1) inch away from the skin 91 of the vehicle 110. With the system operating at about 150 watts, the floating ground plane 140, or skin 141 of the vehicle 110, becomes inductively coupled to the antenna 115. In this manner, the vehicle 110 or skin 141 of the vehicle 110 becomes part of the antenna system 111.

The location of the antenna 115 relative to the top surface of the vehicle 110 has an effect on the performance of the antenna 115. The antenna 115 may be located on the back vertical surface 145 of the vehicle 110 and is preferably located so that the upper edge 116 of the antenna 115 is located at or near to the top surface 147 of the vehicle 110. That is, preferably the top edge 116 of the radiating surface 112 is located even with or just slightly above the top surface 147 of the vehicle. By locating the majority of the antenna 115 behind the moving vehicle 110, the antenna 115 will be better protected from the elements. In addition, locating the antenna 115 partially, substantially or entirely above the vehicle 110 provides roughly the same performance benefits as mounting the top edge 116 of the radiating element 112 just at or slight above the top surface 147 of the vehicle 110. The amount of offset or distance that the antenna is mounted behind the vehicle 110 also effects where vertically on the vehicle the antenna could be located without diminishing the performance of the antenna. In other words, an antenna 115 that was mounted further behind the vehicle 110 could have the top edge 116 of the radiating element 112 located lower relative to the top surface 147 of the vehicle 110 than an antenna 115 mounted closer to the back of the vehicle 110. In this regard, it is contemplated that antenna 115 may in some embodiments be positioned on the vehicle so that the top edge 116 of the antenna 115 is located slightly below the top surface of the vehicle 147.

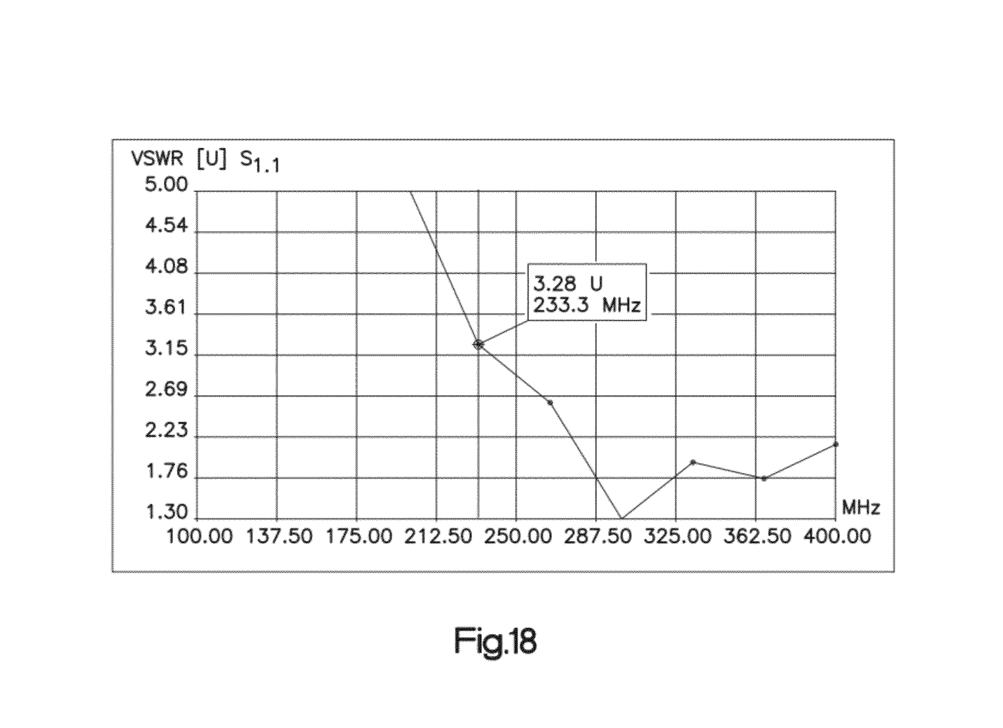

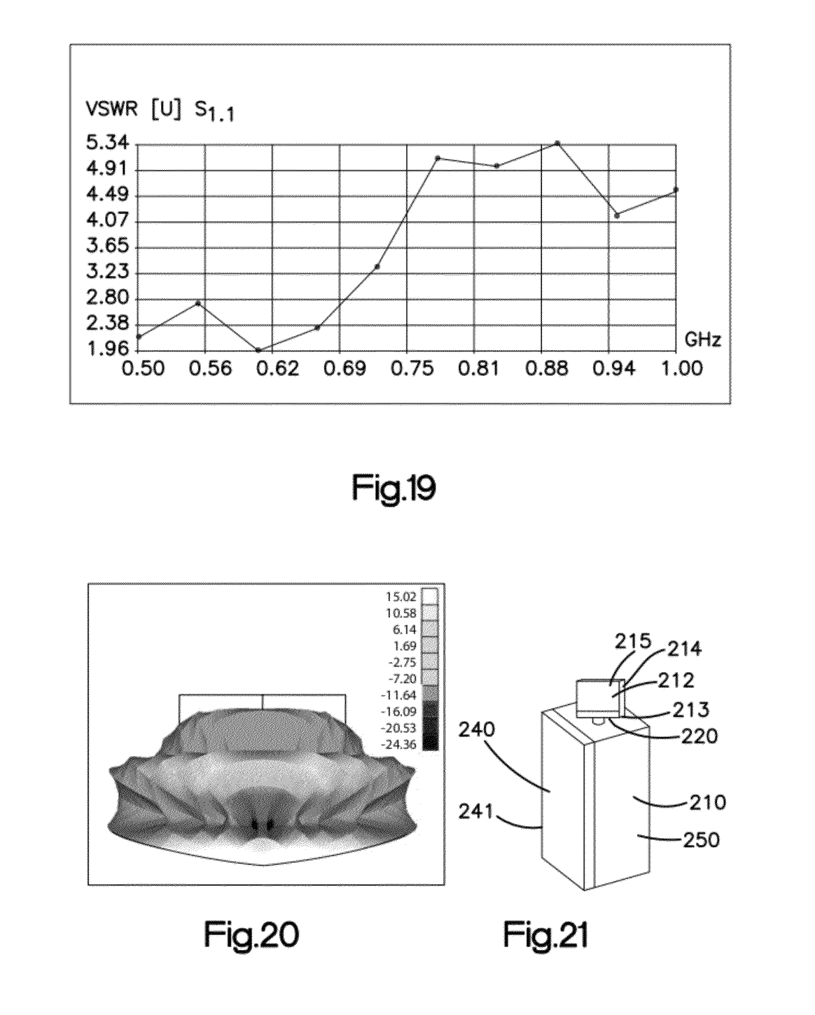

FIG. 18 shows the low frequency response (the VSWR) of the CPA antenna 115 of example 3 mounted or offset one (1) inch away from the vehicle platform 110 and with the top edge 116 of the antenna 115 just about even with or just peeking over the top surface 147 of the vehicle 110. FIG. 19 shows the high frequency response (VSWR) of the CPA antenna 115 of example 3 mounted or offset one (1) inch away from the vehicle platform 110 with the top edge 116 of the antenna 115 just about even with or just peeking over the top surface 147 of the vehicle 110. FIGS. 18 and 19 show that the CP antenna of example 3 performs well from a frequency of about 233 MHz to better than about 750 MHz. FIG. 20 shows the predicted radiation pattern of the antenna 115 in example 3 from the rear showing how the vehicle itself has become part of the antenna system 111.

### Example 4

As shown in FIG. 21 a circularly polarized antenna 215 constructed as per FIGS. 6 & 7, and FIG. 10 has a radiating element 212 having a length l of 60 mm and a height or width of 45 mm formed on a printed circuit board 214. The conductive radiating element 212 is formed about 5 mm from the bottom edge of the printed circuit board and a coupler 220 as shown in FIGS. 6 & 7, FIG. 9 or FIG. 10 is attached along the bottom edge of the printed circuit board 214 so that an antenna ground 213 is formed about five (5) mm from the radiating element 212. The antenna 215 is mounted on the housing 250 of a wireless device 210. Housing 250 is preferably non conductive. A metal foil 241 formed of aluminum or copper is wrapped around the housing 250 and located in proximity to the antenna 215, including the antenna ground 213. The metal foil or ground plane may be roughly about 125 mm by about 100 mm. The metal foil 241 is about twenty (20) mm to about eighty (80) mm from the antenna 215 including specifically from the antenna ground 213 and forms floating ground plane 240. The wireless device 210 operates at roughly 0.6 watts and has good performance over a broad frequency band from about 600 MHz to about 2.8 GHz.

### Example 5

The antenna 15 of FIG. 10 is mounted on plastic housing of a wireless phone. The radiating element 12 is formed on a printed circuit board 14 and has a length of about eight (8) mm to about ten (10) mm, a height or width of about ten (10) mm to about twelve (12) mm and is located about two (2) mm from the bottom edge of the printed circuit board. A plate formed of metal and integral with the signal conductor 20 is attached along the bottom edge of the printed circuit board and forms the ground 13 of the antenna 15. The ground 13 of the antenna 15 is isolated from the radiating element 12 by the printed circuit board 14 and is about 2 mm from the radiating element 12. A metal foil 41 is wrapped around the housing of the wireless phone to form a floating ground plane 40. The floating ground plane 40 may be about as close as (1) mm, preferably about two (2) mm, and may be as far as about five (5) mm or farther from the antenna 15, and preferably from the ground 13 of the antenna 15. In this manner the floating ground plane 40 preferably is inductively coupled to the antenna 15.

### Example 6

An antenna of the design illustrated in FIG. 5 is constructed on a printed circuit board 14 having a radiating element 12 having a length of about seventy-five (75) mm, and a height or width of about fifteen (15) mm to about twenty (20) mm, and an antenna ground 13 having a length of about fifteen (15) mm to about twenty (20) mm, and a height or width of about sixty (60) mm, where the radiating element 12 is about two (2) mm from the antenna ground 13 on the printed circuit board. A metal foil 41 is wrapped around the back of the housing of the wireless device (like metal foil 241 shown in FIG. 21) and the printed circuit board antenna 15 is mounted over the metal foil 41 so that the metal radiating element 12 and antenna ground 13 face the metal foil 41. The printed circuit board is mounted so that the antenna 15 is electrically isolated from the metal foil 41 and about 2 mm from the metal foil 41.

The size of the antennas 15, 65, 115 and 215 generally varies depending upon the frequency band at which the antenna is intended to work, where higher frequencies generally utilize smaller size radiating elements. In addition, in the examples above, the floating ground plane preferably is connected to the ground of the device or platform. The dedicated or floating ground plane in one embodiment may take the form of a metal strip, band, foil, thin sheet, wire mesh, plate, block or coating, but is not limited to these embodiments or forms. The grounding plane preferably has some mass and dimensional size, with the mass and size preferably being varied depending upon the application and to impedance match with the one or more antenna. Preferably the floating ground plane may be copper, gold, aluminum, sheet steel or other conductive metals. The floating grounding plane preferably is close to the antenna to inductively couple the floating grounding plane to the antenna. The floating ground plane may be located at a distance of about one (1) millimeter to about thirty (30) millimeters from the antenna. In one embodiment the antenna was located about six (6) inches from the floating ground plane. The distance between the floating ground plane and the antenna may vary by the device, application and packaging requirements. In certain embodiments the floating ground plane preferably is closer to the antenna than the ground of the device. The floating ground plane being closer to the antenna, in these certain embodiments, may be more important than the floating ground plane being closer to the ground of the wireless device. The additional floating ground plane inductively couples with the device's antenna and enables the floating ground plane and the device to become part of the overall antenna radiating system.

The principles and examples explained above can also be used in a method to improve the antenna system of existing wireless devices, including improving the range, EIRP and signal reception and transmission performance and characteristics of wireless devices. The principles and examples may also be used to create a broadband antenna system. That is, in one aspect of the method, the principles explained and taught above can be used to retrofit existing antenna systems on wireless devices to provide improved performance including at least increased frequency band width response (VSWR), range, EIRP, and substantially omni-directional characteristics.

In one embodiment of the method, the existing antenna system on a wireless device, for example, a dipole antenna, can be exchanged for one of the circularly polarized antenna described and shown in FIGS. 3-10. The circularly polarized antenna in one embodiment preferably has a planar shaped, conductive radiating element that is formed as a relatively thin sheet or coating on a substrate, such as a printed circuit board, such as shown in FIGS. 5-10. The planar radiating element preferably is isolated from a ground of the antenna. The antenna ground may be in the form of a planar shaped, conductive material that is formed as a thin sheet or coating on a substrate that is in the same plane of orientation as the radiating element as shown in FIGS. 3-4 and 8-9. In one embodiment, the conductive radiating element and conductive antenna ground are formed on a printed circuit board using printed circuit board technology such as shown in FIGS. 5, 8 and 9. In another embodiment, the conductive antenna ground can form a plate or other shape such as part of a coupler as shown in FIGS. 6-7 and 10. The feed connected to the antenna has one lead connected to the radiating element and the other lead connected to the antenna ground.

In the method of improving the performance of the antenna system for a wireless device, a conductive strip, band, foil, sheet, coating, wire mesh, plate or block of metal may be added to the wireless device to form a floating ground plane. The floating ground plane is preferably inductively coupled to the antenna by electrically isolating the floating ground plane from the antenna, yet placing the floating ground plane in appropriate close proximity to the antenna. The floating ground plane preferably is electrically connected to the ground of the wireless device.

The size of the radiating element may be varied depending upon the frequency of intended operation with generally higher frequencies utilizing smaller radiating elements. The size of the antenna ground is generally, preferably larger than the radiating element (and may include larger mass and/or dimensional size). Generally, the size of the floating ground plane preferably is larger than the antenna ground (and may include larger mass and/or dimensional size). Generally, the larger and more massive the floating ground plane, the greater the performance and VSWR of the antenna. The size of the conductive floating ground plane added to the wireless device will vary depending upon the power level that the antenna system is designed to operate, with higher power generally requiring larger floating ground planes. Also, the distance that the floating ground plane is from the antenna is effected by the power that the antenna operates. The higher the power of operation, generally the larger the distance between the floating ground plane and the antenna in order to prevent arcing or a short from occurring between the antenna and the floating ground plane. Generally, the closer the floating ground plane can be placed to the antenna without arcing or shorting, the better the performance and VSWR of the antenna system. The power that the antenna operates at also effects the distance that the antenna ground is located from the antenna radiating element with higher powers generally requiring a larger distance between the antenna ground and the radiating element in order to prevent arcing, a short or a grounding from occurring.

In another embodiment, the antenna system performance may be improved by adding a circularly polarized antenna as described above, or switching out a different existing antenna for a circularly polarized antenna as described above, and mounting the CP antenna in such a manner so that the conductive housing or platform to which the CP antenna is attached is inductively coupled to the CP antenna. The CP antenna is preferably electrically isolated from the conductive housing or platform and yet mounted in close proximity to the platform so that the antenna becomes inductively coupled to the platform for the desired power levels of operation. To further improve antenna performance and provide protection to the antenna, the top edge of the radiating element is preferably about even with or slightly above the top surface of the platform, with the remainder of the antenna, including the antenna ground and the majority of the radiating element mounted behind or alongside the vehicle.

For the desired frequency and power level at which the wireless device operates, the size of the radiating element, and the distance between the floating ground plane and the antenna, and specifically the ground of the antenna, may be adjusted in order to optimize the VSWR of the antenna at the desired frequency or frequency band widths.

The antenna system in one embodiment of the present invention preferably provides a high frequency antenna system that is substantially omni-directional including, but not limited to, for example, an antenna system that is substantially omni-directional at 1.2 GHz, 2.4 GHz and 5.8 GHz frequency bands, is not straight line of sight operational, has longer range by in part incurring less losses so that the antenna operates at greater than about 33% EIRP and as high as about 95% EIRP, and is responsive over a larger frequency band thus permitting one antenna to be used over a larger band width.

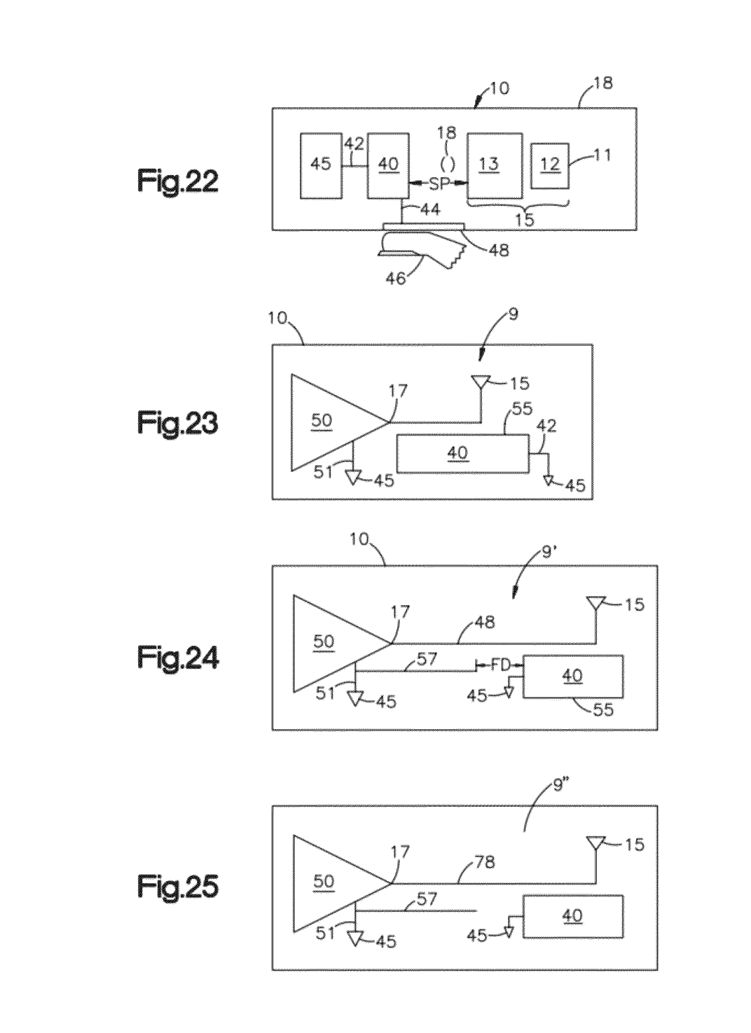

Particular attenuation problems as discussed in the Background section may occur when a wireless device is held by its user or a user comes into close proximity to the wireless device. For ease of reference such wireless devices will be referred to as “hand held” wireless devices, although they may not be portable or held by a user's hand, and it has been found that particular methods are advantageous at reducing or eliminating detuning and ground out effects of such antenna systems when handled by a user. The method and hand held wireless device 10 are schematically illustrated in FIG. 22, where the device has a housing 18 which includes an antenna 15, preferably a circularly polarized antenna, having a radiating element 12 separated a distance “d” from conductive antenna ground 13. The hand held wireless device preferably further includes a floating ground plane 40 that is located sufficiently close to the antenna to inductively couple the floating ground plane 40 to the antenna 15. The floating ground plane 40 preferably is electrically connected to the ground 45 of the device 10 by a wire or lead 42. In addition, the floating ground plane 40 is preferably electrically connected by a wire or lead 44 to a conductive contact 48 accessible preferably to physical contact by a user, illustrated in FIG. 22 by a user's thumb 46. Having the user contact a conductive contact 48 on the exterior of housing 18 which is electrically connected to the floating ground plane 48, preferably and advantageously capacitively couples the user to the wireless device 10, and preferably to the floating ground plane 40. In the embodiment of FIG. 22, the housing 18 may be formed of non-conductive material, non-conductive material and conductive material, or conductive material. If housing 18 is formed of conductive material or parts are formed of conductive material, then the floating ground plane may be electrically connected to the conductive parts of the housing 18, preferably where a user is likely or intended to contact the housing. Alternatively or additionally, if the conductive parts of the housing 18 are unlikely to be contacted by a user during use, then it may be advantageous to include a further conductive contact 48 in a location accessible and likely to be contacted by a user.

In an embodiment of the improved antenna system 9 of the present invention shown in FIG. 23, a transmitting, receiving, or transceiver device 10, such as, for example, a cordless or wireless phone, uses one or more circularly polarized antenna 15, preferably one or more circularly polarized dipole-like antenna that have an asymmetric dipole design. Circularly polarized antennas 15 of a design that will work with device 10 include the antennas shown and described in U.S. Pat. No. 7,733,280, particularly the design of FIGS. 1-6. FIGS. 6, 7 & 10 of the present application also show the design of a circularly polarized antenna 15 that has worked in a Uniden 1.9 GHz cordless phone. The antenna of FIGS. 6 & 7 was configured for 1.9 GHz and is shown next to a United States quarter and dime to provide approximate, relative dimensions. The size of the antenna(s) 15 generally would vary depending upon the frequency band at which the antenna is intended to work.

The output 17 or input 17, depending upon whether the antenna 15 is transmitting or receiving a signal, of a power amplifier 50 is connected to the antenna 15. The power amplifier 50 is also electrically connected to ground 45 of the wireless device 10 by lead 51. In addition, the wireless device 10 may include a dedicated or floating grounding plane 40 in proximity to the ground 45 of the power amplifier 50. In one or more embodiments, for example in cellular phones, the floating ground plane 40 may be about one (1) mm to about one (1) cm to the ground 45 of the power amplifier 50. The floating ground plane 40 is also preferably connected to ground 45. The dedicated ground plane 40 may take the form of a conductive material, for example a metal strip, band, foil, mesh, plate, block, coating or sheet 55, but is not limited to these embodiments or forms. The grounding plane preferably has some mass and size, with the mass and size preferably being varied depending upon the application and to impedance match with the one or more antenna 15. Preferably the metal strip 55 may be copper, gold, aluminum or other conductive metals. The floating grounding plane 40, in a preferred embodiment, metal strip 55, preferably is close to the antenna 15 to inductively couple the grounding plane 40 (metal strip 55) to the antenna 15. The floating ground plane may be located at a distance of about five (5) to about eight (8) millimeters from the antenna 15 in one representative example used for cell phone applications. The distance between the floating ground plane and the antenna may vary by the device, application and packaging requirements. In the embodiment of FIG. 23, the floating ground plane 40 preferably is closer to the antenna 15 than the ground 45 of power amplifier 50. The floating grounding plane 40 being closer to the antenna 15 is typically more important than the floating grounding plane 40 being closer to the ground 45 of the power amplifier 50. This additional grounding plane 40 permits the user to be capacitively coupled to the device's antenna so that the user does not detune or ground out the antenna, and preferably the user becomes part of the overall antenna radiating system.

An example of a practical application of the embodiment of FIG. 22 is configuring the metal band or ring that surrounds the newly introduced Apple iPhone 4 to serve as or be electrically connected to a floating ground plane so that the user is coupled to the phone's antenna and becomes part of the overall antenna radiating system. This may be accomplished in one embodiment by adding a small strip of copper 55 in the phone to act as part of the floating ground plane 40 and connecting the small strip of copper 55 by a length of coaxial cable 44a to the metal band that surrounds the Apple iPhone 4. The small strip of copper 55 may be about one (1) mm to about one (1) cm in length, preferably about one (1) cm, about 2.5 centimeters to about 3 centimeters in width, and about 1/32 of an inch in thickness. The strip of conductive metal may be relatively thin compared to its length and width, but may also form a plate or block of material. Other sizes for the metal strip 55 are also contemplated, and the size and mass of the strip may change depending upon the application and for impedance matching purposes. For example, the metal strip 55 may be about one or more grams and may change depending upon the application. Metal strip 55 preferably acts as a floating ground plane 30 and is positioned to be in close proximity to the one or more antennas 15 present in the phone to inductively couple the floating ground plane 40 to the one or more antenna 15. The copper strip 55 may also in this embodiment be close to the ground 45 of the power amplifier 50. In this manner, the metal ring or band surrounding the Apple iPhone 4 is connected to and becomes part of the floating ground plane 40, and further the metal ring or band present in the iPhone 4 preferably is contacted by and connects the user of the phone through the coaxial cable 44a to the metal strip 55 and capacitively couples the user to the phone's antenna 15 so the user becomes part of the antenna radiating system.

Another embodiment of the antenna system is shown in FIG. 24. In the embodiment of the present invention shown in FIG. 24, a transmitting, receiving, or transceiver device 10, such as, for example, a wireless phone, has an antenna system 9′ that uses one or more circularly polarized antenna 15, preferably one or more circularly polarized dipole-like antenna that have an asymmetric dipole design. Circularly polarized antennas 15 of a design that will work with device 10 include the antennas shown and described in U.S. Pat. No. 7,733,280, particularly the design of FIGS. 1-6. FIGS. 6, 7 & 10 of the present application also show the design of a circularly polarized antenna 15 that has worked in a Uniden 1.9 GHz cordless phone. The size of the antennas 15 generally would vary depending upon the frequency band at which the antenna is intended to work.

The output 17 or input 17, depending upon whether the antenna 15 is transmitting or receiving a signal, of a power amplifier 50 is connected to the antenna 15 by a length of coaxial cable 48. The power amplifier 50 is also connected by a lead 51 to ground 45. In addition, the wireless device 10 may include a dedicated or floating grounding plane 40. The floating ground plane 40 is also preferably electrically connected to ground 45. As opposed to the embodiment of FIG. 23, the floating ground plane 40 in the embodiment of FIG. 24 is positioned farther away from the power amplifier and further away from the ground of the power amplifier. Preferably a length of coaxial cable 57 is connected to lead 51 and extends toward and is in close proximity to the floating ground plane 40. Preferably the end of the cable 57 is no more than a distance of about 10 millimeters from the floating ground plane 40 and the length of cable 57 is about 1.5 centimeters to about 3.5 centimeters, and preferably as short as possible to reduce losses. The dedicated or floating ground plane 40 may take the form of a metal strip, band, foil, plate, block, sheet, mesh, or coating 55, but is not limited to these embodiments or forms. The grounding plane preferably has some mass and size, with the mass and size preferably being varied depending upon the application and to impedance match with the one or more antenna 15. Preferably the metal strip 55 may be copper, gold, aluminum, sheet steel or other conductive metals. The floating grounding plane 40, in a preferred embodiment, metal strip 55, preferably is close to the antenna 15 to inductively couple the grounding plane 40 to the antenna 15. The floating ground plane 40 may be located at a distance of about five (5) millimeters to about eight (8) millimeters from the antenna 15 in one representative example used for example in cell phone applications. The distance between the floating ground plane and the antenna may vary by the device, application and packaging requirements. Preferably the floating ground plane 40 is closer to the antenna 15 than the ground 45 of power amplifier 50. The floating grounding plane 40 being closer to the antenna 15 is more important in this embodiment than the floating grounding plane 40 being closer to the ground 45 of the power amplifier 50. This additional floating grounding plane 40 permits the user to be capacitively coupled to the device's antenna 15 using the techniques discussed above in reference to FIG. 22 and become part of the overall antenna radiating system.

Another embodiment of the antenna system is shown in FIG. 25. In this embodiment of the present invention shown in FIG. 25, a transmitting, receiving, or transceiver device 10, such as, for example, a wireless phone, has an antenna system 9″ that uses one or more circularly polarized antenna 15, preferably one or more circularly polarized dipole-like antenna that have an asymmetric dipole design. Circularly polarized antennas 15 of a design that will work with device 10 include the antennas shown and described in U.S. Pat. No. 7,733,280, particularly the design of FIGS. 1-6. FIGS. 6, 7 & 10 of the present application also show the design of a circularly polarized antenna 15 that has worked in a Uniden 1.9 GHz cordless phone. The size of the antennas 15 generally would vary depending upon the frequency band at which the antenna is intended to work.

The output 17 or input 17, depending upon whether the antenna 15 is transmitting or receiving a signal, of a power amplifier 50 is connected to the antenna 15 by a length of coaxial cable 78. The power amplifier 50 is also connected by a lead 51 to ground 45. In addition, the wireless device 10 may include a dedicated or floating grounding plane 40. Preferably, a length of coaxial cable 57 is connected to lead 51 and extends toward and is in close proximity to the floating ground plane 40. The dedicated ground plane 40 may take the form of a metal strip, band, foil, mesh, plate, block, sheet or coating 55, but is not limited to these embodiments or forms. The floating grounding plane preferably has some mass and size, with the mass and size preferably being varied depending upon the application and to impedance match with the one or more antenna 15. Preferably the floating ground plane 40 may be copper, gold, aluminum, sheet steel or other conductive metals. The floating grounding plane 40, in a preferred embodiment metal strip 55, preferably is close to the antenna 15 to inductively couple the grounding plane 40 to the antenna 15. The floating ground plane 15 may be located at a distance of about five (5) millimeters to about eight (8) millimeters from the antenna 15, for example for use in cell phone applications. The distance between the floating ground plane and the antenna may vary by the device, application and packaging requirements. Preferably the floating ground plane 40 is closer to the antenna 15 than the ground 45 of power amplifier 50. The floating grounding plane 40 being closer to the antenna 15 is more important in this embodiment than the floating grounding plane 40 being closer to the ground 45 of the power amplifier 50. This additional floating grounding plane 40 permits the user to be capacitively coupled to the device's antenna and become part of the overall antenna radiating system using the techniques described when discussing FIG. 22. For example, the floating ground plane 40 can be connected by a coaxial cable to a conductive member on the housing 10 of the wireless device, the conductive member configured and intended to be contacted by a user when using the wireless or cordless phone.

In the embodiment of FIG. 25, the impedance of the amplifier 50 is matched to the impedance of the antenna 15 by adjusting the length of the coaxial cable 78 connecting the antenna 15 and the power amplifier 50. In the embodiment of FIG. 25, the coaxial cable 78 preferably is sized (e.g., its length is adjusted) so that its length is greater than or equal to about 0.2 to about 0.15 times the effective corrected wavelength of the antenna. The antenna generally will not be tuned to resonate at exactly the frequency that it is intended to work at which is referred to as the wavelength error. So the length of the coaxial cable is adjusted so that its length is equal to or greater than about 0.2 to about 0.15 times that wave length error. Thus, for example, if an antenna will operate (resonate) from 1.9 GHz to 2.4 GHz but it is preferred that it operate at 1.925 GHz, the effective corrected wavelength would be the sum of (1.925−1.9)+(2.4−1.925) divided by 2 to get the average error of the antenna (Ae). That wavelength or antenna error Ae is multiplied by about 0.15 to about 0.2 to get a length in mm for the coaxial cable 78 that is connected between the power amplifier 50 and the antenna 15. In one representative example, for use in cell phones for example, the length of the coaxial cable 78 may be about one centimeter to about 1.5 centimeters, preferably about 1.2 centimeters.

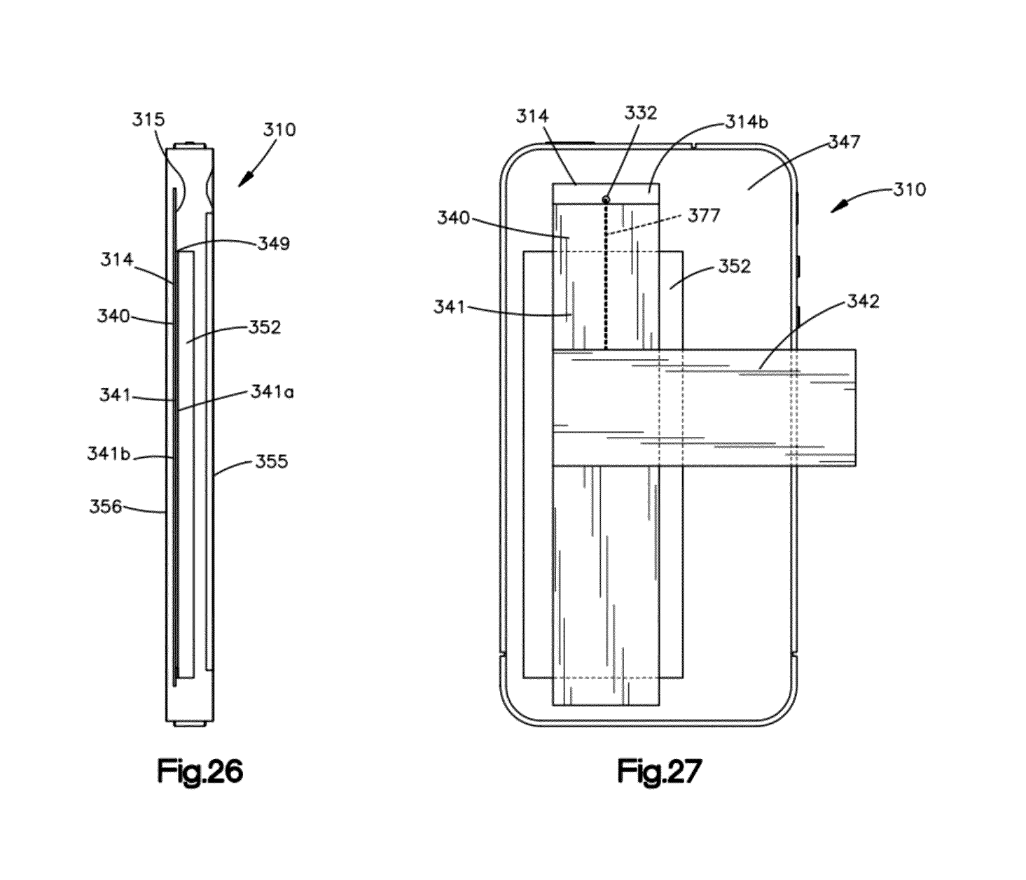

In another embodiment of the invention which advantageously may reduce a user's exposure to the radiation effects of wireless devices, particularly, for example, wireless phones, is shown in FIGS. 26-32 and preferably includes a floating ground plane 340 positioned and configured sufficiently close to and electrically isolated from the antenna 315, preferably a circularly polarized antenna, so as to inductively couple the floating ground plane 340 to the antenna 315. The floating ground plane 340 preferably is further positioned and configured in the wireless device so that it substantially covers or overlaps the area of the antenna, and or the antenna components. The antenna 315 further preferably faces toward the front of the wireless device and/or the side or face of the wireless device that faces the user while the floating ground plane faces the back of the wireless device.

Referring to FIGS. 26-30, a wireless device 310, in the example, an Apple mobile phone, is shown that has been modified to include an antenna 315, preferably a circularly polarized antenna 315, and a floating ground plane 340. The CP antenna 315 is formed on a printed circuit board 314 that is approximately 95 mm to approximately 105 mm in height, preferably about 100 mm, and about 18 mm to about 22 mm in length, more preferably about 20 mm. As shown in FIGS. 26-29, the CP antenna 315 and copper strip 341 assembly (described below) is placed over the battery pack 352 so that the antenna components face the battery pack 352 and the front 355 of the wireless device 310. The copper strip 341, which forms the floating ground plane 340, faces the back 356 of the wireless device. A small air gap 349 of about two (2) mm is present between the antenna 315 and the battery pack 352. There preferably should be sufficient distance between the antenna 315 and copper strips 341, 342 to sufficiently remove or reduce the adverse effects that may be caused by the electric field of the battery pack 352.

As shown in FIGS. 28 and 29, a first side 314a of the printed circuit board 314 has a radiating element 312 sized and configured to be resonate at 800 MHz, 825 MHz, 900 MHz, 1900 MHz and 2.4 GHz. In the embodiment shown, the radiating element 312 has a height of about 80 mm to about 90 mm, preferably about 87 mm, and a width of about 18 mm to about 22 mm, preferably about 20 mm. An antenna ground 313 is also formed on the first side 314a of the printed circuit board 314 and has a width of about 12 mm to about 16 mm, more preferably about 14-15 mm, and a height of about 12 mm to about 15 mm, more preferably about 13 mm. The radiating element 312 is separated from the antenna ground 313 by about 1 mm to about 3 mm, more preferably about 1 mm.

As shown in FIG. 217, the back side 314b of the printed circuit board 314 is covered with a strip 341 of copper foil. In this example, the strip of copper 341 is approximately 20 mm in width, and about 90 mm to about 110 mm, more preferably about 100 mm, in height. An additional strip or tab 342 of copper foil extends from the side edge of printed circuit board 314, and will be positioned to extend to or beyond the housing 310 of the wireless device so that it can be contacted by a user of the wireless device, or connected to a conductive contact on the housing which is intended to be contacted by a user. The copper strip 341 and tab 342 form a ground plane 340 that preferably is inductively coupled to the antenna. The floating ground plane 340 may be formed of a single piece of preferably conductive material, or by multiple pieces of the same or different material, and more than one grounding plane may be utilized. More specifically the copper strip 341 which forms the grounding plane 340 is about one (1) mm to two (2) mm from the antenna 315 and electrically isolated from the antenna components, in this example, by the thickness of the printed circuit board material.

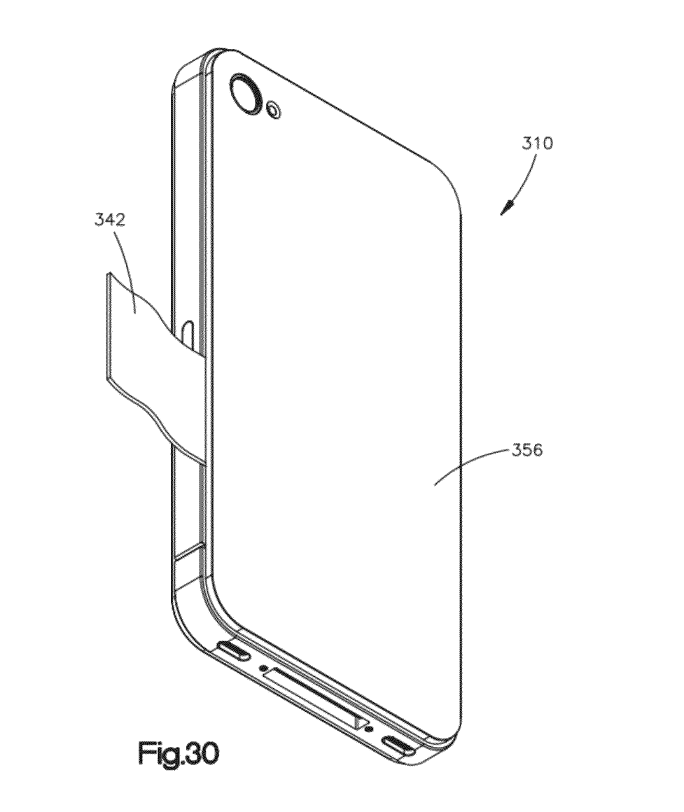

In the example shown in FIGS. 26-30, the back of the wireless device 310, as shown in FIGS. 27 and 29, is covered with insulating material 347, such as, for example, electrical tape, although other materials are contemplated. When the back cover shown in FIG. 29 with the assembled antenna 315, copper strip 341 and copper tab 342 is placed over the body of the phone (over the battery pack), the radiating element 312 and antenna ground 313 face the battery pack 352 and the front 355 of the wireless device 310. The copper strip 341 which forms the grounding plane 340 faces the back 356 of the wireless device 310. The copper strip tab 342 extends out of the wireless housing 310 to a location on the exterior of the device's housing, as shown in FIG. 30, where a user preferably makes contact with the copper strip tab 342 during the operation of the wireless device 310 so that the user is capacitively coupled to the wireless device. In the finished device, the copper tab 342 is incorporated and finished into the housing or electrically connected to a conductive contact to be touched by the user during operation of the wireless device. While in the embodiment of FIGS. 26-30 the antenna 315 and grounding plane 340 have been assembled as a unit or assembly, and then the assembly has been placed in the wireless device, the antenna 315 and floating ground plane 340 can be assembled separately in the device.

A signal feed 332 is connected to the antenna 315 preferably by a coaxial cable and coupler 320. More particularly there is a junction on the back side of the printed circuit board 314 to which the coupler 320 connects. One conductor of the coaxial cable connects to the radiating element 312 while the conductive shielding on the coaxial cable connects to antenna ground 313. A lead 377 shown in phantom in FIG. 27 is connected by the junction to the conductive shielding on the coaxial cable or ground of the wireless device and is also in electrical contact with the copper strip 341 and the antenna ground.

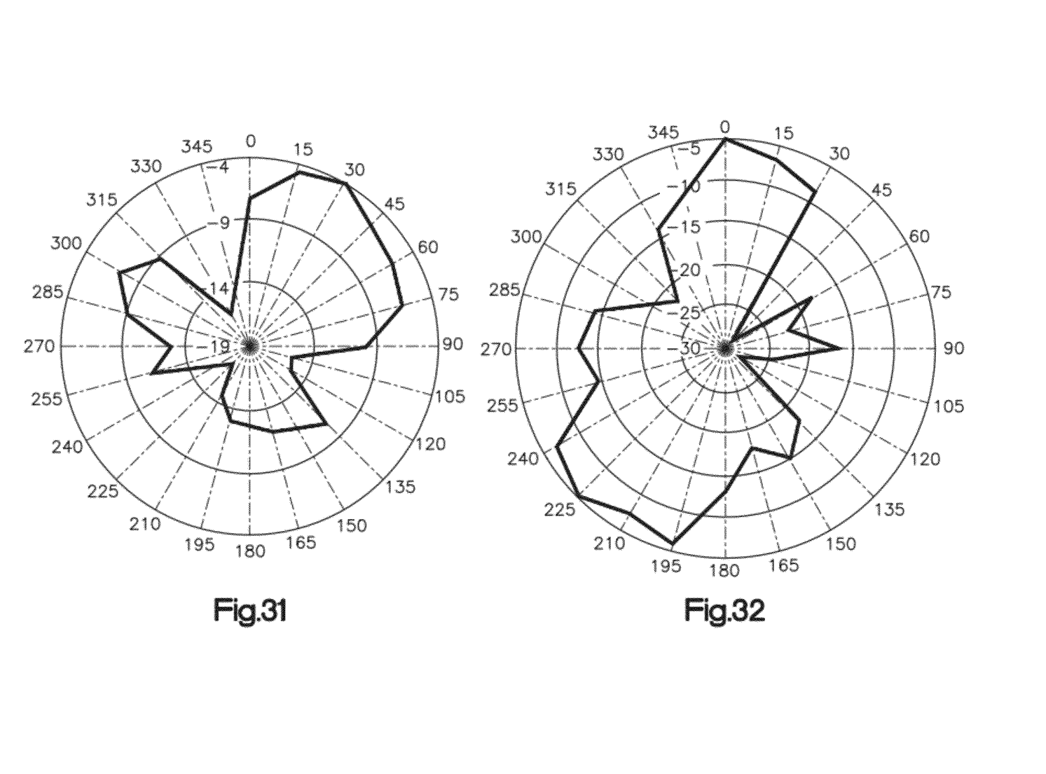

FIG. 31 shows the gain of the antenna of the wireless phone illustrated in FIGS. 26-30 where a user does not contact the phone during operation. FIG. 32 shows the gain of the antenna when a user contacts the copper tab 342 that extends out of the housing and has the phone against his ear. The phone in the chart of FIG. 32 is positioned so that the user's ear is at 90°. It should be noted that the scale of FIG. 31 is different than the scale of FIG. 32. It is noteworthy that the gain of the antenna system, as shown by comparing FIG. 31 to FIG. 32, has improved when contacted by the user, and the user is believed to be coupled to and become part of the antenna system. In addition, when the phone of FIGS. 26-30 is contacted by a user so that the user preferably is capacitively coupled to the floating ground plane and becomes part of the antenna system, the signal propagation changes so that the signal propagates away from the front of the device, and hence, away from the head of the wireless phone operator who has the phone against his ear. In FIG. 31, the signal propagated predominately between 0° to 90°, which would be toward the front of the device and toward the user, but in FIG. 32, the signal propagated primarily between 195° and 240° with a secondary lobe between 30° and 330°. The signal when the user contacts the floating ground plane not only propagates away from the head, the signal is also distributed over a larger area so that there is less signal concentration at a user's head.

It will be appreciated by those skilled in the art that changes could be made to the embodiments described above without departing from the broad inventive concept thereof. For example, while many of the embodiments have disclosed and described the use of a single circularly polarized antenna, it is contemplated that multiple circularly polarized antennas can be utilized, and additionally, that a single or multiple linear antennas may be used singularly or in combination with circularly polarized antennas.

Still further, it is contemplated that one or more floating ground planes can be utilized and, although the description and preferred embodiments have referred to and shown foils and coatings as the grounding planes; plates, blocks, rings, polygonal and amorphous shapes can be utilized for the grounding plane (such as, for example, the conductive band around the Apple iPhone 4), and the grounding plane need not form a “plane” or have a flat, planar shape. It is understood, therefore, that this invention is not limited to the particular embodiments disclosed, but it is intended to cover modifications within the spirit and scope of the present invention as reasonably disclosed a taught to those of ordinary skill in the art by the present description.

I claim:

1. An antenna system comprising:
a circularly polarized antenna for transmitting or receiving a signal,
a floating ground plane,
wherein the floating ground plane is electrically isolated and in proximity to the antenna so that floating ground plane is inductively coupled to the antenna.

2. The antenna system of claim 1 wherein the floating grounding plane comprises one of the group of a strip, band, foil, mesh, sheet, plate and block of conductive metal.

3. The antenna system of claim 2 wherein the floating grounding plane is a relatively thin copper or aluminum foil.

4. The antenna system of claim 1 wherein the circularly polarized antenna has a radiating element and an antenna ground and the radiating element is electrically isolated from and located about one (1) mm to about ten (10) mm from the ground of the antenna.

5. The antenna system of claim 1 wherein the circularly polarized antenna has a planar shaped, conductive radiating element formed as a relatively thin sheet, foil or coating having a length and height and which radiates from its edges.

6. The antenna system of claim 5 wherein radiating element is formed on a printed circuit board.

7. The antenna system of claim 6 wherein the radiating element has a thickness of about one (1) mm to about two (2) mm.

8. The antenna system of claim 5 wherein the circularly polarized antenna further includes a planar shaped, conductive antenna ground formed as a relatively thin sheet, foil or coating.

9. The antenna system of claim 8 wherein the radiating element and the antenna ground are both formed on a printed circuit board and oriented in the same plane.

10. The antenna system of claim 8 wherein the radiating element and the antenna ground are both formed on printed circuit board and oriented in different planes.

11. The antenna system of claim 5 wherein circularly polarized antenna includes an antenna ground that is isolated from and located about two (2) mm to about ten (10) mm from the radiating element.

12. The antenna system of claim 11 wherein the antenna ground and the radiating element are formed on a printed circuit board.

13. The antenna system of claim 5 wherein the circularly polarized antenna has an antenna ground that is larger than the radiating element.

14. The antenna system of claim 5 wherein the circularly polarized antenna has a planar shaped, conductive antenna ground formed as a relatively thin sheet, foil or coating wherein the antenna ground has at least one dimension that is about three (3) to about four (4) times larger than the respective dimension of the radiating element.

15. The antenna system of claim 5 wherein the floating ground plane is larger than the radiating element.

16. The antenna system of claim 13 wherein the floating ground plane is larger than the antenna ground.

17. The antenna system of claim 5 wherein the circularly polarized antenna has a conductive antenna ground and the floating ground plane is more massive or larger than the antenna ground.

18. The antenna system of claim 1 wherein the circularly polarized antenna includes a planar conductive radiating element and a conductive antenna ground wherein the floating ground plane, radiating element and antenna ground are sized and located so that the radiating element is electrically isolated from the antenna ground and the floating ground plane, and the antenna ground is spaced from and electrically isolated from the radiating element and the floating ground plane.

19. The antenna of claim 2 wherein the floating ground plane is about 0.5 centimeters to about 125 centimeters in length and about 0.5 centimeters to about 125 centimeters in width.

20. The antenna system of claim 1 wherein circularly polarized antenna includes a conductive planar shaped radiating element and an antenna ground, and the floating ground plane is about one (1) mm to about thirty (30) mm to the antenna ground.

21. The antenna system of claim 20 wherein the floating ground plane is approximately one (1) mm to about ten (10) mm to the ground of the antenna.

22. The antenna system of claim 20 wherein the radiating element has a length of about 25 mm to about 250 mm and a height of about 20 mm to about 180 mm.

23. The antenna system of claim 20 wherein the antenna ground has a length of about 115 mm to about 990 mm and a height of about 55 mm to about 990 mm.

24. The antenna system of claim 20 further including a signal coupler, wherein the signal coupler comprises the antenna ground.

25. The antenna system of claim 18 wherein the floating ground plane is connected to the ground of the wireless device.

26. The antenna system of claim 18 used in a handheld portable wireless device.

27. The antenna system of claim 18 used in a moveable vehicle.

28. The antenna system of claim 1 further comprising a power amplifier electrically connected to the circularly polarized antenna and electrically connected to the ground of the device.

29. The antenna system of claim 1 further comprising a housing having a conductive contact exposed to an outer surface of the housing and configured to be handled by a user during operation wherein the conductive contact is electrically connected to the floating ground plane.

30. A method of improving an antenna system of a wireless device comprising the steps of
(a) providing a circularly polarized antenna;
(b) inductively coupling the circularly polarized antenna to a floating ground plane to improve the performance of the antenna system.

31. The method of claim 30 further comprising the step of providing a floating ground plane and placing the floating ground plane in proximity to the circularly polarized antenna to inductively couple the antenna to the floating ground plane.

32. The method of claim 31 further comprising the step of mounting the floating ground plane to or within the housing or platform of the wireless device.

33. The method of claim 30 wherein the circularly polarized antenna has a conductive planar shaped radiating element and further comprising the step of configuring the floating ground plane to be larger or more massive than the radiating element.

34. The method of claim 33, wherein the circularly polarized antenna has a conductive planar shaped antenna ground and further comprising the step of configuring at least one dimension of the antenna ground to be about three (3) to about (4) times larger than the respective dimension of the radiating element.

35. The method of claim 30 wherein the circularly polarized antenna has a conductive planar shaped radiating element and antenna ground further comprising configuring the proportional size and relative spatial distances between the floating ground plane, the radiating element and the antenna ground to achieve an acceptable VSWR to effectively propagate a signal.

36. The method of claim 35 wherein the radiating element, antenna ground and floating ground plane are configured and arranged to obtain a VSWR at a desired frequency band of less than 3:1.

37. The method of claim 35 wherein the radiating element, antenna ground and floating ground plane are configured and arranged to obtain a VSWR at a desired frequency band of less than 2:1.

38. The method of claim 30 further comprising the step of capacitively coupling the user to the floating ground plane.

39. The method of claim 38 comprising the step of connecting the user to the floating ground plane.

40. The method of claim 39 wherein at least a portion of the housing is conductive and is electrically connected to the floating ground plane further comprising the step of the user touching the portion of the housing that is electrically connected to the floating ground plane.

41. The method of claim 30 further comprising coupling the user to the floating ground plane so that the user becomes part of the antenna system.

42. An antenna system for a wireless device comprising:
a housing for interfacing with a user, the housing comprising a conductive member;
a circularly polarized antenna for transmitting or receiving a signal; and
a floating ground plane,
wherein the floating ground plane is electrically isolated from and in sufficient proximity to the antenna so that it is inductively coupled to the antenna, and wherein the conductive member is electrically connected to the floating ground plane.

43. The antenna system of claim 42 wherein the floating grounding plane is a relatively thin metallic foil.

44. The antenna system of claim 43 wherein the foil is about 0.5 centimeters to about 1.5 centimeters in length and about 2.5 centimeters to about 3 centimeters in width.

45. The antenna system of claim 42 wherein the floating ground plane is located a distance of about 5 millimeters to about 8 millimeters from the antenna.

46. The antenna system of claim 42 wherein the floating ground plane is connected to ground of the wireless device.

47. The antenna system of claim 42 further comprising a power amplifier electrically connected to the circularly polarized antenna and electrically connected to the ground of the wireless device.

48. The antenna system of claim 47 wherein the floating ground plane is connected to the conductive member by a coaxial cable.

49. The antenna system of claim 47 wherein the floating ground plane is in proximity to the ground of the power amplifier.

50. The antenna system of claim 47 wherein the floating ground plane is approximately 1 millimeter to about 1 centimeter to the ground of the power amplifier.

51. The antenna system of claim 47 wherein a coaxial cable connects the antenna to the power amplifier.

52. The antenna system of claim 47 wherein a coaxial cable connects the power amplifier to the antenna and the length of the coaxial cable connecting the antenna to the power amplifier is selected to match the impedance of the antenna to the impedance of the power amplifier.

53. The antenna system of claim 47 wherein a coaxial cable connects the power amplifier to the antenna and its length is greater than or equal to about 0.15 effective corrected wavelength of the antenna.

54. The antenna system of claim 53 wherein the coaxial cable extending between the power amplifier and the antenna is about one (1) centimeter to about one and a half (1.5) centimeters in length.

55. The antenna system of claim 47 further comprising a coaxial cable extending from the lead connecting the power amplifier to ground toward the floating ground plane.

56. The antenna system of claim 55 wherein the coaxial cable extending from the lead of the power amplifier ground is no more than about ten (10) millimeters from the floating ground plane.

57. The antenna system of claim 42 wherein the floating ground plane substantially covers the antenna.

58. The antenna system of claim 42 wherein the floating ground plane is configured and arranged to propagate electromagnetic signals away from the front of the housing intended to be directed toward the head of a user.

59. The antenna system of claim 42 wherein the conductive contact is arranged and configured so that the user is coupled to the antenna system and becomes part of the antenna system.

60. A wireless device having an antenna system, the antenna system comprising:
a housing for interfacing with a user having an outer surface, a front side and a back side, the front side configured to be directed toward a user when in use, the housing having a conductive contact on the outer surface and configured to be contacted by the user;
a circularly polarized antenna for receiving and or transmitting signals; and
a floating ground plane configured and arranged to be electrically isolated from and in sufficient proximity to the antenna so that it is inductively coupled to the antenna, and
wherein the floating ground plane is further arranged and configured to propagate electromagnetic signals away from the front of the housing.

61. The wireless device of claim 60 wherein the conductive contact is electrically connected to the floating ground plane.

62. The wireless device of claim 60 wherein the floating ground plane is sized and configured to substantially overlap the area of the antenna.

63. The wireless device of claim 60 wherein the floating ground plane is arranged and configured to face the back of the housing and the antenna is configured to face the front of the housing.

64. The wireless device of claim 60 wherein the antenna has antenna components comprising a radiating element and antenna ground formed as substantially planar coatings on a first side of a printed circuit board and the grounding plane is formed as a relatively thin foil of conductive metal that substantially overlies the second side of the printed circuit board where the antenna components are positioned, and wherein the printed circuit board assembly is positioned in the housing so that the first side of the printed circuit board faces the front of the housing and the second side of the printed circuit board faces the back of the housing.

65. The wireless device of claim 60 wherein the floating ground plane is formed as a metallic foil located about one (1) mm to about 2 (two) mm from the antenna.

66. The wireless device of claim 60 wherein the housing is sized and configured to be holdable and the floating ground plane is capacitively coupled to the user so that the user forms part of the antenna system.
